(19) United States
(12) Patent Application Publication
(10) Pub. No.: US 2022/0060751 A1
(43) Pub. Date: Feb. 24, 2022

(54) IMAGE ENCODING/DECODING METHOD AND DEVICE FOR PERFORMING MIP AND LFNST, AND METHOD FOR TRANSMITTING BITSTREAM

(71) Applicant: LG Electronics Inc., Seoul (KR)

(72) Inventors: Jung Hak NAM, Seoul (KR); Moonmo KOO, Seoul (KR); Jaehyun LIM, Seoul (KR); Seung Hwan KIM, Seoul (KR)

(21) Appl. No.: 17/521,086

(22) Filed: Nov. 8, 2021

Related U.S. Application Data
(63) Continuation of application No. PCT/KR2020/005982, filed on May 7, 2020.
(60) Provisional application No. 62/844,751, filed on May 8, 2019.

(51) Int. Cl. H04N 19/61; H04N 19/159; H04N 19/18; H04N 19/176

(52) U.S. Cl. CPC H04N 19/619; H04N 19/176; H04N 19/18; H04N 19/159

(57) ABSTRACT

An image encoding/decoding method and apparatus are provided. An image decoding method according to the present disclosure may comprise generating a prediction block by performing intra prediction with respect to a current block, generating a residual block by performing inverse transform with respect to a transform coefficient of the current block, and reconstructing the current block based on the prediction block and the residual block. The inverse transform may comprise inverse primary transform and inverse secondary transform, and the inverse secondary transform may be performed based on whether intra prediction for the current block is matrix based intra prediction (MIP).

### CROSS-REFERENCE TO RELATED APPLICATIONS

Pursuant to 35 U.S.C. § 119(e), this application is a continuation of International Application PCT/KR2020/005982, with an international filing date of May 7, 2020, which claims the benefit of U.S. Provisional Patent Application No. 62/844,751, filed on May 8, 2019, the contents of which are hereby incorporated by reference herein in its entirety.

### TECHNICAL FIELD

The present disclosure relates to an image encoding/decoding method and apparatus and, more particularly, to an image encoding/decoding method and apparatus for applying a low frequency non-separable transform (LFNST) for a block, to which matrix based intra prediction (MIP) applies, and a method of transmitting a bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide a method and apparatus for encoding/decoding an image by applying LFNST for a block to which MIP applies.

Another object of the present disclosure is to provide a method of transmitting a bitstream generated by an image encoding method or apparatus according to the present disclosure.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

The technical problems solved by the present disclosure are not limited to the above technical problems and other technical problems which are not described herein will become apparent to those skilled in the art from the following description.

### Technical Solution

An image decoding method according to an aspect of the present disclosure may comprise generating a prediction block by performing intra prediction with respect to a current block, generating a residual block by performing inverse transform with respect to a transform coefficient of the current block, and reconstructing the current block based on the prediction block and the residual block. The inverse transform may comprise inverse primary transform and inverse secondary transform, and the inverse secondary transform may be performed based on whether intra prediction for the current block is matrix based intra prediction (MIP).

In the image decoding method according to the present disclosure, the inverse secondary transform may be performed only upon determining that inverse secondary transform is performed with respect to the transform coefficient.

In the image decoding method according to the present disclosure, the determination as to whether inverse secondary transform may be performed with respect to the transform coefficient is performed based on information signaled through a bitstream.

In the image decoding method according to the present disclosure, the inverse secondary transform may comprise determining a transform set of inverse secondary transform based on an intra prediction mode of the current block, selecting one of a plurality of transform kernels included in the transform set of the inverse secondary transform, and performing the inverse secondary transform based on the selected transform kernel.

In the image decoding method according to the present disclosure, based on the intra prediction for the current block being MIP, the intra prediction mode of the current block used to determine the transform set of the inverse secondary transform may be derived as a predetermined intra prediction mode

In the image decoding method according to the present disclosure, based on the intra prediction for the current block being MIP, the predetermined intra prediction mode may be derived from an MIP mode of the current block based on a predefined mapping table.

In the image decoding method according to the present disclosure, based on the intra prediction for the current block being MIP, the predetermined intra prediction mode may be derived as a planar mode.

In the image decoding method according to the present disclosure, based on the intra prediction for the current block being MIP, inverse secondary transform for the transform coefficient is skipped.

In the image decoding method according to the present disclosure, based on the intra prediction for the current block being MIP, information specifying whether inverse secondary transform is performed with respect to the transform coefficient may not be signaled through a bitstream.

In the image decoding method according to the present disclosure, based on the intra prediction for the current block being MIP, a transform kernel for inverse secondary transform of the transform coefficient may be determined to be a predetermined transform kernel, without being signaled through a bitstream

In the image decoding method according to the present disclosure, the number of transform kernels available in a case where the current block is subjected to MIP may be less than the number of transform kernels available in a case where the current block is not subjected to MIP

In the image decoding method according to the present disclosure, first information specifying whether inverse secondary transform applies to the current block and second information specifying a transform kernel used for the inverse secondary transform may be signaled as separate information, and the second information may be signaled based on the first information specifying that inverse secondary transform applies to the current block.

An image decoding apparatus according to another embodiment of the present disclosure may comprise a memory and at least one processor. The at least one processor may generate a prediction block by performing intra prediction with respect to a current block, generate a residual block by performing inverse transform with respect to a transform coefficient of the current block, and reconstruct the current block based on the prediction block and the residual block. The inverse transform may comprise inverse primary transform and inverse secondary transform, and the inverse secondary transform may be performed based on whether intra prediction for the current block is MIP.

An image encoding method according to another aspect of the present disclosure may comprise generating a prediction block by performing intra prediction with respect to a current block, generating a residual block of the current block based on the prediction block, and generating a transform coefficient by performing transform with respect to the residual block. The transform may comprise primary transform and secondary transform, and the secondary transform may be performed based on whether intra prediction for the current block is MIP.

In addition, a transmission method according to another aspect of the present disclosure may transmit the bitstream generated by the image encoding apparatus or the image encoding method of the present disclosure.

In addition, a computer-readable recording medium according to another aspect of the present disclosure may store the bitstream generated by the image encoding apparatus or the image encoding method of the present disclosure.

The features briefly summarized above with respect to the present disclosure are merely exemplary aspects of the detailed description below of the present disclosure, and do not limit the scope of the present disclosure.

### Advantageous Effects

According to the present disclosure, an image encoding/decoding method and apparatus with improved encoding/decoding efficiency may be provided.

According to the present disclosure, a method and apparatus for encoding/decoding an image by applying LFNST for a block to which MIP applies may be provided.

Also, according to the present disclosure, a method of transmitting a bitstream generated by an image encoding method or apparatus according to the present disclosure may be provided.

Also, according to the present disclosure, a recording medium storing a bitstream generated by an image encoding method or apparatus according to the present disclosure may be provided.

Also, according to the present disclosure, a recording medium storing a bitstream received, decoded and used to reconstruct an image by an image decoding apparatus according to the present disclosure may be provided.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a view schematically showing a video coding system, to which an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an embodiment of the present disclosure is applicable.

FIG. 4 is a view showing a partitioning type of a block according to a multi-type tree structure.

FIG. 5 is a view showing a signaling mechanism of partition splitting information in a quadtree with nested multi-type tree structure according to the present disclosure.

FIG. 6 is a flowchart illustrating an intra prediction based video/image encoding method.

FIG. 7 is a view showing the configuration of the intra prediction unit 185 according to the present disclosure.

FIG. 8 is a flowchart illustrating an intra prediction based video/image decoding method.

FIG. 9 is a view showing the configuration of the intra prediction unit 265 according to the present disclosure.

FIG. 10 is a flowchart illustrating an intra prediction mode signaling procedure in an image encoding apparatus.

FIG. 11 is a flowchart illustrating an intra prediction mode determination procedure in an image decoding apparatus.

FIG. 12 is a flowchart illustrating an intra prediction mode derivation procedure in more detail.

FIG. 13 is a view showing an intra prediction direction according to an embodiment of the present disclosure.

FIG. 14 is a view showing an intra prediction direction according to another embodiment of the present disclosure.

FIG. 15 is a view illustrating an ALWIP process for a 4×4 block.

FIG. 16 is a view illustrating an ALWIP process for an 8×8 block.

FIG. 17 is a view illustrating an ALWIP process for an 8×4 block.

FIG. 18 is a view illustrating an ALWIP process for a 16×16 block.

FIG. 19 is a view illustrating an averaging step of an ALWIP process according to the present disclosure.

FIG. 20 is a view illustrating an interpolation step of an ALWIP process according to the present disclosure.

FIG. 21 is a view illustrating a transform method applying to a residual block.

FIG. 22 is a flowchart illustrating a method of performing a secondary transform/inverse transform according to the present disclosure.

FIG. 23 is a view illustrating a method performed by an image decoding apparatus based on whether to apply MIP and LFNST according to another embodiment of the present disclosure.

FIG. 24 is a view illustrating a method performed by an image encoding apparatus based on whether to apply MIP and LFNST according to another embodiment of the present disclosure.

FIG. 25 is a view showing a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean “a luma block of a current block” unless explicitly stated as a chroma block. The “chroma block of the current block” may be expressed by including an explicit description of a chroma block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

Overview of Video Coding System

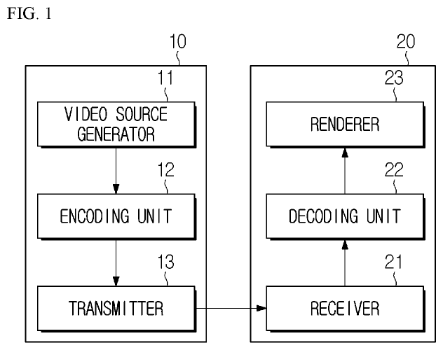

FIG. 1 is a view showing a video coding system according to the present disclosure.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

Overview of Image Encoding Apparatus

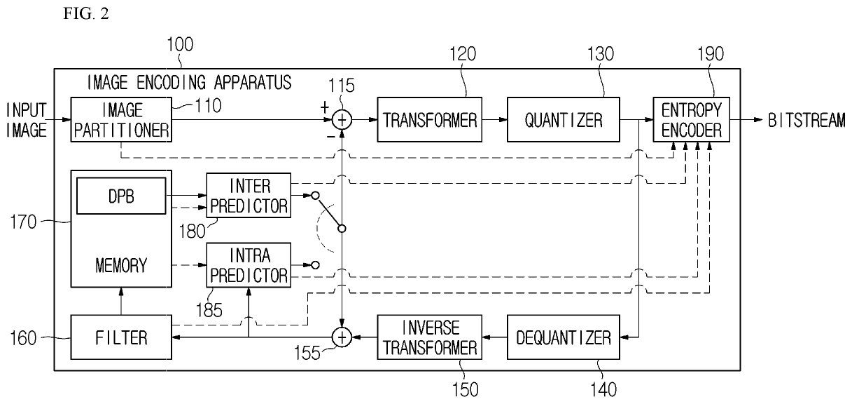

FIG. 2 is a view schematically showing an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighbouring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighbouring block and the current block. The motion information may include a motion vector and a reference picture index. The motion information may further include inter prediction direction (L0 prediction, L1 prediction, Bi prediction, etc.) information. In the case of inter prediction, the neighbouring block may include a spatial neighbouring block present in the current picture and a temporal neighbouring block present in the reference picture. The reference picture including the reference block and the reference picture including the temporal neighbouring block may be the same or different. The temporal neighbouring block may be called a collocated reference block, a co-located CU (colCU), and the like. The reference picture including the temporal neighbouring block may be called a collocated picture (colPic). For example, the inter prediction unit 180 may configure a motion information candidate list based on neighbouring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighbouring block as motion information of the current block. In the case of the skip mode, unlike the merge mode, the residual signal may not be transmitted. In the case of the motion vector prediction (MVP) mode, the motion vector of the neighbouring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block form into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighbouring block or the motion information of the temporal neighbouring block. The memory 170 may store reconstructed samples of reconstructed blocks in the current picture and may transfer the reconstructed samples to the intra prediction unit 185.

Overview of Image Decoding Apparatus

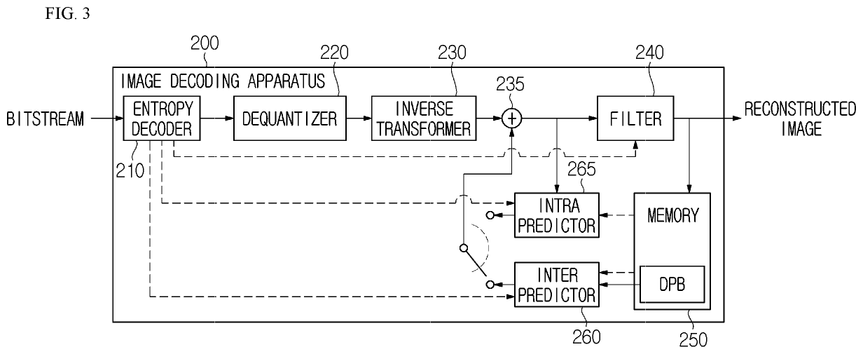

FIG. 3 is a view schematically showing an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 170 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighbouring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighbouring block and the current block. The motion information may include a motion vector and a reference picture index. The motion information may further include inter prediction direction (L0 prediction, L1 prediction, Bi prediction, etc.) information. In the case of inter prediction, the neighbouring block may include a spatial neighbouring block present in the current picture and a temporal neighbouring block present in the reference picture. For example, the inter prediction unit 260 may configure a motion information candidate list based on neighbouring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighbouring block or the motion information of the temporal neighbouring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

Overview of Partitioning of CTU

As described above, the coding unit may be acquired by recursively partitioning the coding tree unit (CTU) or the largest coding unit (LCU) according to a quad-tree/binary-tree/ternary-tree (QT/BT/TT) structure. For example, the CTU may be first partitioned by quadtree structures. Thereafter, leaf nodes of the quadtree structure may be further partitioned by a multi-type tree structure.

Partitioning according to quadtree means that a current CU (or CTU) is partitioned into equally four. By partitioning according to quadtree, the current CU may be partitioned into four CUs having the same width and the same height. When the current CU is no longer partitioned by the quadtree structure, the current CU corresponds to the leaf node of the quad-tree structure. The CU corresponding to the leaf node of the quadtree structure may be no longer partitioned and may be used as the above-described final coding unit. Alternatively, the CU corresponding to the leaf node of the quadtree structure may be further partitioned by a multi-type tree structure.

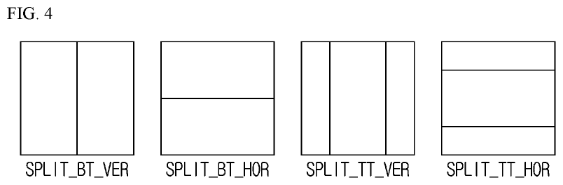

FIG. 4 is a view showing an embodiment of a partitioning type of a block according to a multi-type tree structure. Partitioning according to the multi-type tree structure may include two types of splitting according to a binary tree structure and two types of splitting according to a ternary tree structure.

The two types of splitting according to the binary tree structure may include vertical binary splitting (SPLIT_BT_VER) and horizontal binary splitting (SPLIT_BT_HOR). Vertical binary splitting (SPLIT_BT_VER) means that the current CU is split into equally two in the vertical direction. As shown in FIG. 4, by vertical binary splitting, two CUs having the same height as the current CU and having a width which is half the width of the current CU may be generated. Horizontal binary splitting (SPLIT_BT_HOR) means that the current CU is split into equally two in the horizontal direction. As shown in FIG. 4, by horizontal binary splitting, two CUs having a height which is half the height of the current CU and having the same width as the current CU may be generated.

Two types of splitting according to the ternary tree structure may include vertical ternary splitting (SPLIT_TT_VER) and horizontal ternary splitting (SPLIT_TT_HOR). In vertical ternary splitting (SPLIT_TT_VER), the current CU is split in the vertical direction at a ratio of 1:2:1. As shown in FIG. 4, by vertical ternary splitting, two CUs having the same height as the current CU and having a width which is ¼ of the width of the current CU and a CU having the same height as the current CU and having a width which is half the width of the current CU may be generated. In horizontal ternary splitting (SPLIT_TT_HOR), the current CU is split in the horizontal direction at a ratio of 1:2:1. As shown in FIG. 4, by horizontal ternary splitting, two CUs having a height which is ¼ of the height of the current CU and having the same width as the current CU and a CU having a height which is half the height of the current CU and having the same width as the current CU may be generated.

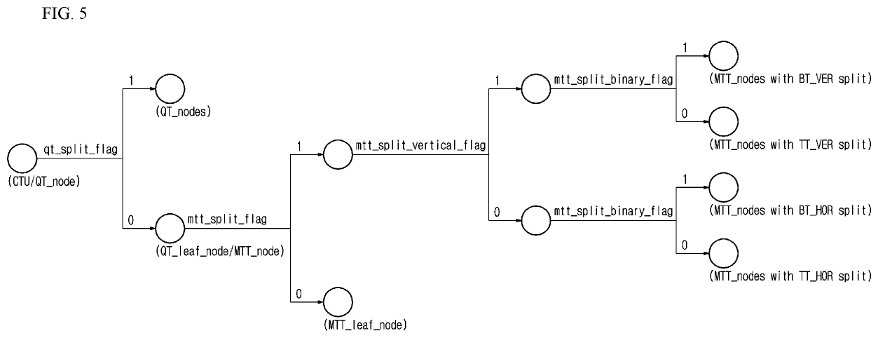

FIG. 5 is a view showing a signaling mechanism of partition splitting information in a quadtree with nested multi-type tree structure according to the present disclosure.

Here, the CTU is treated as the root node of the quadtree, and is partitioned for the first time by a quadtree structure. Information (e.g., qt_split_flag) indicating whether quadtree splitting is performed with respect to the current CU (CTU or node (QT_node) of the quadtree) may be signaled. For example, when qt_split_flag has a first value (e.g., “1”), the current CU may be quadtree-partitioned. In addition, when qt_split_flag has a second value (e.g., “0”), the current CU is not quadtree-partitioned, but becomes the leaf node (QT_leaf_node) of the quadtree. Each quadtree leaf node may then be further partitioned into multitype tree structures. That is, the leaf node of the quadtree may become the node (MTT_node) of the multi-type tree. In the multitype tree structure, a first flag (e.g., mtt_split_cu_flag) is signaled to indicate whether the current node is additionally partitioned. If the corresponding node is additionally partitioned (e.g., if the first flag is 1), a second flag (e.g., mtt_split_cu_vertical_flag) may be signaled to indicate the splitting direction. For example, the splitting direction may be a vertical direction if the second flag is 1 and may be a horizontal direction if the second flag is 0. Then, a third flag (e.g., mtt_split_cu_binary_flag) may be signaled to indicate whether the split type is a binary split type or a ternary split type. For example, the split type may be a binary split type when the third flag is 1 and may be a ternary split type when the third flag is 0. The node of the multi-type tree acquired by binary splitting or ternary splitting may be further partitioned by multi-type tree structures. However, the node of the multi-type tree may not be partitioned by quadtree structures. If the first flag is 0, the corresponding node of the multi-type tree is no longer split but becomes the leaf node (MTT leaf node) of the multi-type tree. The CU corresponding to the leaf node of the multi-type tree may be used as the above-described final coding unit.

Based on the mtt_split_cu_vertical_flag and the mtt_split_cu_binary_flag, a multi-type tree splitting mode (MttSplitMode) of a CU may be derived as shown in Table 1 below.

TABLE 1

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

One CTU may include a coding block of luma samples (hereinafter referred to as a “luma block”) and two coding blocks of chroma samples corresponding thereto (hereinafter referred to as “chroma blocks”). The above-described coding tree scheme may be equally or separately applied to the luma block and chroma block of the current CU. Specifically, the luma and chroma blocks in one CTU may be partitioned into the same block tree structure and, in this case, the tree structure may be represented as SINGLE_TREE. Alternatively, the luma and chroma blocks in one CTU may be partitioned into separate block tree structures, and, in this case, the tree structure may be represented as DUAL_TREE. That is, when the CTU is partitioned into dual trees, the block tree structure for the luma block and the block tree structure for the chroma block may be separately present. In this case, the block tree structure for the luma block may be called DUAL_TREE_LUMA, and the block tree structure for the chroma component may be called DUAL_TREE_CHROMA. For P and B slice/tile groups, luma and chroma blocks in one CTU may be limited to have the same coding tree structure. However, for I slice/tile groups, luma and chroma blocks may have a separate block tree structure from each other. If the separate block tree structure is applied, the luma CTB may be partitioned into CUs based on a particular coding tree structure, and the chroma CTB may be partitioned into chroma CUs based on another coding tree structure. That is, a CU in an I slice/tile group, to which the individual block tree structure applies, may include a coding block of luma components or coding blocks of two chroma components. In addition, a CU in an I slice/tile group, to which the same block tree structure applies, and a CU of a P or B slice/tile group may include blocks of three color components (a luma component and two chroma components).

Although a quadtree coding tree structure with a nested multitype tree has been described, a structure in which a CU is partitioned is not limited thereto. For example, the BT structure and the TT structure may be interpreted as a concept included in a multiple partitioning tree (MPT) structure, and the CU may be interpreted as being partitioned through the QT structure and the MPT structure. In an example where the CU is partitioned through a QT structure and an MPT structure, a syntax element (e.g., MPT_split_type) including information on how many blocks the leaf node of the QT structure is partitioned into and a syntax element (ex. MPT_split_mode) including information on which of vertical and horizontal directions the leaf node of the QT structure is partitioned into may be signaled to determine a partitioning structure.

In another example, a CU may be partitioned in a way different from a QT structure, a BT structure or a TT structure. That is, unlike partitioning a CU of a lower depth into a size of ¼ of a CU of a higher depth according to the QT size, partitioning a CU of a lower depth into a size of ½ of a CU of a higher depth according to the BT size or partitioning a CU of a lower depth into a size of ¼ or ½ of a CU of a higher depth according to the TT size, the CU of the lower depth may be partitioned into a size of ⅕, ⅓, ⅜, ⅗, ⅔ or ⅝ of a CU of a higher depth, and a method of partitioning a CU is not limited thereto.

Overview of Intra Prediction

Hereinafter, intra prediction according to an embodiment will be described.

Intra prediction may indicate prediction which generates prediction samples for a current block based on reference samples in a picture to which the current block belongs (hereinafter referred to as a current picture). When intra prediction applies to the current block, neighbouring reference samples to be used for intra prediction of the current block may be derived. The neighbouring reference samples of the current block may include a sample adjacent to a left boundary of the current block having a size of nW×nH and a total of 2×nH samples adjacent to the bottom-left, a sample adjacent to a top boundary of the current block and a total of 2×nW samples adjacent to the top-right, and one sample adjacent to the top-left of the current block. Alternatively, the neighbouring reference samples of the current block may include a plurality of columns of top neighbouring samples and a plurality of rows of left neighbouring samples. In addition, the neighbouring reference samples of the current block may include a total of nH samples adjacent to a right boundary of the current block having a size of nW×nH, a total of nW samples adjacent to a bottom boundary of the current block, and one sample adjacent to the bottom-right of the current block.

Some of the neighbouring reference samples of the current block have not yet been decoded or may not be available. In this case, a decoder may construct neighbouring reference samples to be used for prediction, by substituting unavailable samples with available samples. Alternatively, neighbouring reference samples to be used for prediction may be constructed using interpolation of available samples.

When the neighbouring reference samples are derived, (i) a prediction sample may be derived based on average or interpolation of neighbouring reference samples of the current block and (ii) the prediction sample may be derived based on a reference sample present in a specific (prediction) direction with respect to the prediction sample among the neighbouring reference samples of the current block. The case of (i) may be referred to as a non-directional mode or a non-angular mode and the case of (ii) may be referred to as a directional mode or an angular mode.

In addition, the prediction sample may be generated through interpolation with a first neighbouring sample located in a prediction direction of the intra prediction mode of the current block and a second neighbouring sample located in the opposite direction based on a prediction target sample of the current block among the neighbouring reference samples. The above-described case may be referred to as linear interpolation intra prediction (LIP).

In addition, chroma prediction samples may be generated based on luma samples using a linear model. This case may be called a linear model (LM) mode.

In addition, a temporary prediction sample of the current block may be derived based on filtered neighbouring reference samples, and the prediction sample of the current block may be derived by weighted-summing the temporary prediction sample and at least one reference sample derived according to the intra prediction mode among the existing neighbouring reference samples, that is, the unfiltered neighbouring reference samples. This case may be referred to as position dependent intra prediction (PDPC).

In addition, a reference sample line with highest prediction accuracy may be selected from multiple neighbouring reference sample lines of the current block to derive a prediction sample using a reference sample located in a prediction direction in the corresponding line, and, at this time, information (e.g., intra_luma_ref_idx) on the used reference sample line may be encoded and signaled in a bitstream. This case may be referred to as multi-reference line (MRL) intra prediction or MRL based intra prediction. When MRL does not apply, reference samples may be derived from a reference sample line directly adjacent to the current block. In this case, information on the reference sample line may not be signaled.

In addition, the current block may be split into vertical or horizontal sub-partitions to perform intra prediction with respect to each sub-partition based on the same intra prediction mode. At this time, neighbouring reference samples of intra prediction may be derived in units of sub-partitions. That is, a reconstructed sample of a previous sub-partition in encoding/decoding order may be used as a neighbouring reference sample of a current sub-partition. In this case, the intra prediction mode for the current block equally applies to the sub-partitions and the neighbouring reference samples are derived and used in units of sub-partitions, thereby increasing intra prediction performance. Such a prediction method may be referred to as intra sub-partitions (ISP) or ISP based intra prediction.

The intra prediction technique may be referred to as various terms such as intra prediction type or additional intra prediction mode to be distinguished from a directional or non-directional intra prediction mode. For example, the intra prediction technique (intra prediction type or the additional intra prediction mode) may include at least one of LIP, LM, PDPC, MRL, ISP or MIP. A general intra prediction method excluding a specific intra prediction type such as LIP, LM, PDPC, MRL or ISP may be referred to as a normal intra prediction type. The normal intra prediction type is generally applicable when the above-described specific intra prediction type does not apply, and prediction may be performed based on the above-described intra prediction mode. Meanwhile, if necessary, post-filtering may be performed with respect to the derived prediction sample.

Specifically, the intra prediction procedure may include an intra prediction mode/type determination step, a neighbouring reference sample derivation step and an intra prediction mode/type based prediction sample derivation step. In addition, if necessary, post-filtering may be performed with respect to the derived prediction sample.

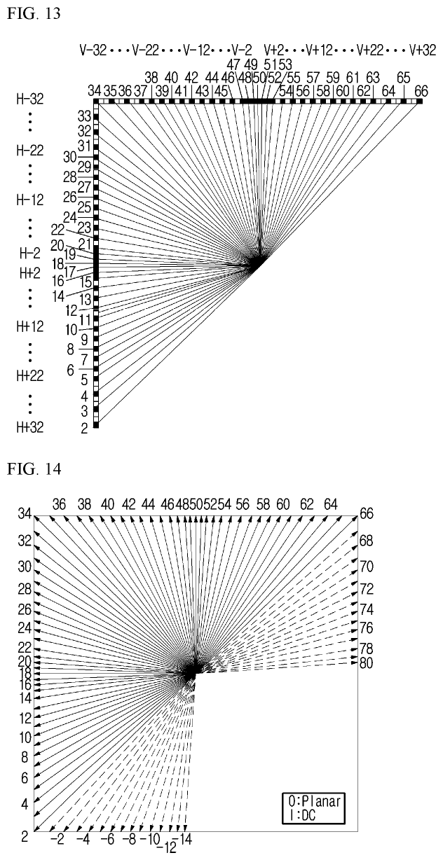

Meanwhile, in addition to the above-described intra prediction types, affine linear weighted intra prediction (ALWIP) may be used. ALWIP may be referred to as linear weighted intra prediction (LWIP), matrix weighted intra prediction (MWIP) or matrix based intra prediction (MIP). When ALWIP applies for a current block, i) neighbouring reference samples on which an averaging procedure has been performed may be used, ii) a matrix-vector-multiplication procedure may be performed, iii) a horizontal/vertical interpolation process may be further performed if necessary, thereby deriving prediction samples for the current block. Intra prediction modes used for ALWIP may be constructed differently from intra prediction modes used for the above-described LIP, PDPC, MRL or ISP intra prediction or normal intra prediction (intra prediction modes described with reference to FIG. 13 and/14 FIG. 14). The intra prediction mode for ALWIP may be referred to as an ALWIP mode, an LWIP mode, a MWIP mode or a MIP mode. For example, a matrix and an offset used in the matrix vector multiplication may be set differently according to the intra prediction mode for ALWIP. Here, the matrix may be referred to as an (affine) weighted matrix, and the offset may be referred to as an (affine) offset vector or an (affine) bias vector. A specific ALWIP method will be described later.

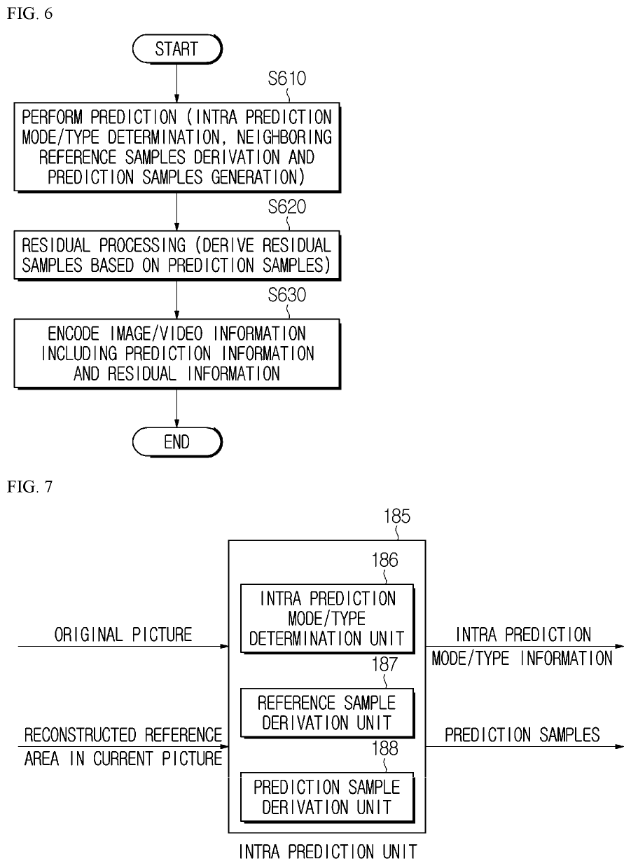

FIG. 6 is a flowchart illustrating an intra prediction based video/image encoding method.

The encoding method of FIG. 6 may be performed by the image encoding apparatus of FIG. 2. Specifically, step S610 may be performed by the intra prediction unit 185, and step S620 may be performed by the residual processor. Specifically, step S620 may be performed by the subtractor 115. Step S630 may be performed by the entropy encoder 190. The prediction information of step S630 may be derived by the intra prediction unit 185, and the residual information of step S630 may be derived by the residual processor. The residual information is information on the residual samples. The residual information may include information on quantized transform coefficient for the residual samples. As described above, the residual samples may be derived as transform coefficient through the transformer 120 of the image encoding apparatus, and the transform coefficient may be derived as the transform coefficients quantized through the quantizer 130. The information on the quantized transform coefficients may be encoded by the entropy encoder 190 through a residual coding procedure.

The image encoding apparatus may perform intra prediction with respect to a current block (S610). The image encoding apparatus may determine an intra prediction mode/type for the current block, derive neighbouring reference samples of the current block, and generate prediction samples in the current block based on the intra prediction mode/type and the neighbouring reference samples. Here, the intra prediction mode/type determination, neighbouring reference samples derivation and prediction samples generation procedures may be simultaneously performed or any one procedure may be performed before the other procedures.

FIG. 7 is a view illustrating the configuration of an intra prediction unit 185 according to the present disclosure.

As shown in FIG. 7, the intra prediction unit 185 of the image encoding apparatus may include an intra prediction mode/type determination unit 186, a reference sample derivation unit 187 and/or a prediction sample derivation unit 188. The intra prediction mode/type determination unit 186 may determine an intra prediction mode/type for the current block. The reference sample derivation unit 187 may derive neighbouring reference samples of the current block. The prediction sample derivation unit 188 may derive prediction samples of the current block. Meanwhile, although not shown, when the below-described prediction sample filtering procedure is performed, the intra prediction unit 185 may further include a prediction sample filter (not shown).

The image encoding apparatus may determine a mode/type applying to the current block among a plurality of intra prediction modes/types. The image encoding apparatus may compare rate distortion (RD) cost for the intra prediction modes/types and determine an optimal intra prediction mode/type for the current block.

Meanwhile, the image encoding apparatus may perform a prediction sample filtering procedure. Prediction sample filtering may be referred to as post-filtering. By the prediction sample filtering procedure, some or all of the prediction samples may be filtered. In some cases, the prediction sample filtering procedure may be omitted.

Referring to FIG. 6 again, the image encoding apparatus may generate residual samples for the current block based on the prediction samples or the filtered prediction samples (S620). The image encoding apparatus may derive the residual samples by subtracting the prediction samples from the original samples of the current block. That is, the image encoding apparatus may derive the residual sample values by subtracting the corresponding prediction sample value from the original sample value.

The image encoding apparatus may encode image information including information on the intra prediction (prediction information) and residual information of the residual samples (S630). The prediction information may include the intra prediction mode information and/or the intra prediction technique information. The image encoding apparatus may output the encoded image information in the form of a bitstream. The output bitstream may be transmitted to the image decoding apparatus through a storage medium or a network.

The residual information may include residual coding syntax, which will be described later. The image encoding apparatus may transform/quantize the residual samples and derive quantized transform coefficients. The residual information may include information on the quantized transform coefficients.

Meanwhile, as described above, the image encoding apparatus may generate a reconstructed picture (including reconstructed samples and a reconstructed block). To this end, the image encoding apparatus may perform dequantization/inverse transform with respect to the quantized transform coefficients and derive (modified) residual samples. The reason for transforming/quantizing the residual samples and then performing dequantization/inverse transform is to derive the same residual samples as residual samples derived by the image decoding apparatus. The image encoding apparatus may generate a reconstructed bock including reconstructed samples for the current block based on the prediction samples and the (modified) residual samples. Based on the reconstructed block, the reconstructed picture for the current picture may be generated. As described above, an in-loop filtering procedure is further applicable to the reconstructed picture.

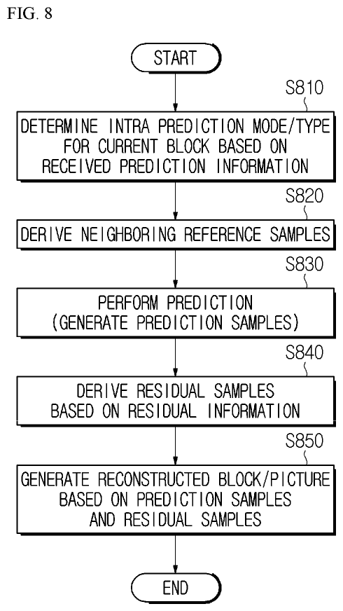

FIG. 8 is a flowchart illustrating an intra prediction based video/image decoding method.

The image decoding apparatus may perform operation corresponding to operation performed by the image encoding apparatus.

The decoding method of FIG. 8 may be performed by the image decoding apparatus of FIG. 3. Steps S810 to S830 may be performed by the intra prediction unit 265, and the prediction information of step S810 and the residual information of step S840 may be obtained from a bitstream by the entropy decoder 210. The residual processor of the image decoding apparatus may derive residual samples for the current block based on the residual information (S840). Specifically, the dequantizer 220 of the residual processor may perform dequantization based on the dequantized transform coefficients derived based on the residual information to derive transform coefficients, and the inverse transformer 230 of the residual processor may perform inverse transform with respect to the transform coefficients to derive the residual samples for the current block. Step S850 may be performed by the adder 235 or the reconstructor.

Specifically, the image decoding apparatus may derive an intra prediction mode/type for the current block based on the received prediction information (intra prediction mode/type information) (S810). The image decoding apparatus may derive neighbouring reference samples of the current block (S820). The image decoding apparatus may generate prediction samples in the current block based on the intra prediction mode/type and the neighbouring reference samples (S830). In this case, the image decoding apparatus may perform a prediction sample filtering procedure. Prediction sample filtering may be referred to as post-filtering. By the prediction sample filtering procedure, some or all of the prediction samples may be filtered. In some cases, the prediction sample filtering procedure may be omitted.

The image decoding apparatus may generate residual samples for the current block based on the received residual information (S840). The image decoding apparatus may generate reconstructed samples for the current block based on the prediction samples and the residual samples and derive a reconstructed block including the reconstructed samples (S850). Based on the reconstructed block, the reconstructed picture for the current picture may be generated. An in-loop filtering procedure is further applicable to the reconstructed picture, as described above.

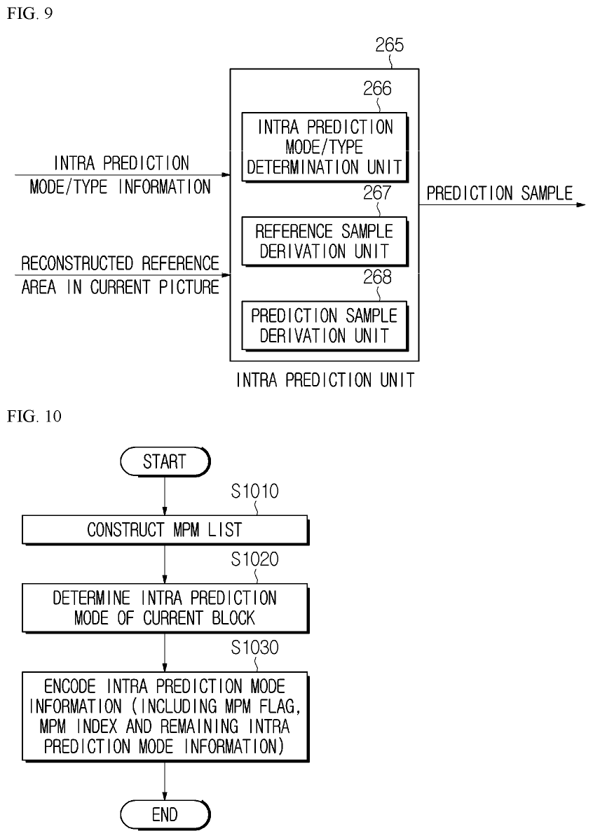

FIG. 9 is a view illustrating the configuration of an intra prediction unit 265 according to the present disclosure.

As shown in FIG. 9, the intra prediction unit 265 of the image decoding apparatus may include an intra prediction mode/type determination unit 266, a reference sample derivation unit 267 and a prediction sample derivation unit 268. The intra prediction mode/type determination unit 266 may determine an intra prediction mode/type for the current block based on the intra prediction mode/type information generated and signaled by the intra prediction mode/type determination unit 186 of the image encoding apparatus, and the reference sample derivation unit 267 may derive neighbouring reference samples of the current block from a reconstructed reference region in a current picture. The prediction sample derivation unit 268 may derive prediction samples of the current block. Meanwhile, although not shown, when the above-described prediction sample filtering procedure is performed, the intra prediction unit 265 may further include a prediction sample filter (not shown).

The intra prediction mode information may include, for example, flag information (e.g., intra_luma_mpm_flag) indicating whether to apply a most probable mode (MPM) or a remaining mode to the current block, and, when the MPM applies to the current block, the intra prediction mode information may further include index information (e.g., intra_luma_mpm_idx) indicating one of the intra prediction mode candidates (MPM candidates). The intra prediction mode candidates (MPM candidates) may be composed of an MPM candidate list or an MPM list. In addition, when the MPM does not apply to the current block, the intra prediction mode information may further include remaining mode information (e.g., intra_luma_mpm_remainder) indicating one of the remaining intra prediction modes excluding the intra prediction mode candidates (MPM candidates). The image decoding apparatus may determine the intra prediction mode of the current block based on the intra prediction mode information. In addition, a separate MPM list may be constructed for the above-described ALWIP. The MPM candidate modes may include the intra prediction modes of the neighbouring blocks (e.g., the left neighbouring block and the upper neighbouring block) of the current block and additional candidate modes.

In addition, the intra prediction technique information may be implemented in various forms. For example, the intra prediction technique information may include intra prediction technique index information indicating one of the intra prediction techniques. As another example, the intra prediction technique information may include at least one of reference sample line information (e.g., intra_luma_ref_idx) indicating whether to apply MRL to the current block and, if applied, which reference sample line is used, ISP flag information (e.g., intra_subpartitions_mode_flag) indicating whether to apply ISP to the current block, ISP type information (e.g., intra_subpartitions_split_flag) indicating the split type of sub-partitions when applying ISP, flag information indicating whether to apply PDPC, or flag information indicating whether to apply LIP. In the present disclosure, ISP flag information may be referred to as an ISP application indicator. In addition, the intra prediction type information may include an ALWIP flag specifying whether ALWIP applies to the current block.

The intra prediction mode information and/or the intra prediction technique information may be encoded/decoded through the coding method described in the present disclosure. For example, the intra prediction mode information and/or the intra prediction technique information may be encoded/decoded through entropy coding (e.g., CABAC, CAVLC) based on a truncated (rice) binary code.

Hereinafter, an intra prediction mode/type determination method according to the present disclosure will be described in greater detail.

When applying intra prediction to a current block, an intra prediction mode applying to the current block may be determined using an intra prediction mode of a neighbouring block. For example, an image decoding apparatus may construct a most probable mode (mpm) list derived based on an intra prediction mode of a neighbouring block (e.g., a left and/or top neighbouring block) of the current block and additional candidate modes and select one of mpm candidates in the mpm list based on a received mpm index. Alternatively, the image decoding apparatus may select one of the remaining intra prediction modes which are not included in the mpm list based on remaining intra prediction mode information. For example, whether the intra prediction mode applying to the current bock is in the mpm candidates (that is, in the mpm list) or in the remaining mode may be indicated based on an mpm flag (e.g., intra_luma_mpm_flag). A value 1 of the mpm flag may indicate that the intra prediction mode for the current block is in the mpm candidates (mpm list) and a value 0 of the mpm flag may indicate that the intra prediction mode of the current block is not in the mpm candidates (mpm list). The mpm index may be signaled in the form of a syntax element mpm_idx or intra_luma_mpm_idx, and the remaining intra prediction mode information may be signaled in the form of a syntax element rem_intra_luma_pred_mode or intra_luma_mpm_remainder. For example, the remaining intra prediction mode information may indicate one of the remaining intra prediction modes which are not included in the mpm candidates (mpm list) among all intra prediction modes and are indexed in order of prediction mode numbers. The intra prediction mode may be an intra prediction mode of a luma component (sample). Hereinafter, the intra prediction mode information may include at least one of the mpm flag (e.g., intra_luma_mpm_flag), the mpm index (e.g., mpm_idx or intra_luma_mpm_idx) or the remaining intra prediction mode information (rem_intra_luma_pred_mode or intra_luma_mpm_remainder). In the present disclosure, the MPM list may be referred to as various terms such as MPM candidate list, candModeList, etc.

FIG. 10 is a flowchart illustrating an intra prediction mode signaling procedure in an image encoding apparatus.

Referring to FIG. 10, the image encoding apparatus may construct an MPM list for a current block (S1010). The MPM list may include candidate intra prediction modes (MPM candidates) which are highly likely to apply to the current block. The MPM list may include the intra prediction mode of a neighbouring block and may further include specific intra prediction modes according to a predetermined method.

The image encoding apparatus may determine the intra prediction mode of the current block (S1020). The image encoding apparatus may perform prediction based on various intra prediction modes and perform rate-distortion optimization (RDO) based on this to determine an optimal intra prediction mode. In this case, the image encoding apparatus may determine the optimal intra prediction mode using only MPM candidates included in the MPM list or determine the optimal intra prediction mode by further using not only the MPM candidates included in the MPM list but also the remaining intra prediction modes. Specifically, for example, if the intra prediction type of the current block is a specific type (e.g., LIP, MRL or ISP) which is not a normal intra prediction type, the image encoding apparatus may determine the optimal intra prediction mode using only the MPM candidates. That is, in this case, the intra prediction mode of the current block may be determined only from the MPM candidates and, in this case, the mpm flag may not be encoded/signaled. The image decoding apparatus may estimate that the mpm flag is 1, without separately receiving the mpm flag, in the case of the specific type.

Meanwhile, in general, when the intra prediction mode of the current is one of the MPM candidates in the MPM list, the image encoding apparatus may generate an mpm index indicating one of the MPM candidates. If the intra prediction mode of the current block is not present in the MPM list, remaining intra prediction mode information indicating the same mode as the intra prediction mode of the current among the remaining intra prediction modes which are not included in the MPM list may be generated.

The image encoding apparatus may encode and output intra prediction mode information in the form of a bitstream (S1030). The intra prediction mode information may include the above-described mpm flag, mpm index and/or remaining intra prediction mode information. In general, the mpm index and the remaining intra prediction mode information have an alternative relationship and thus are not simultaneously signaled in indicating the intra prediction mode of one block. That is, when the value of the mpm flag is 1, the mpm index may be signaled and, when the value of the mpm flag is 0, the remaining intra prediction mode information may be signaled. However, as described above, when applying a specific intra prediction type to the current block, the mpm flag is not signaled and the value thereof is inferred to be 1 and only the mpm index may be signaled. That is, in this case, the intra prediction mode information may include only the mpm index.

Although, in the example shown in FIG. 10, S1020 is shown as being performed after S1010, this is an example and S1020 may be performed before S1010 or they may be simultaneously performed.

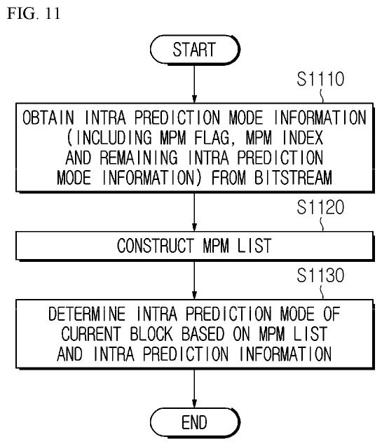

FIG. 11 is a flowchart illustrating an intra prediction mode determination procedure in an image decoding apparatus.

The image decoding apparatus may determine an intra prediction mode of a current block based on the intra prediction mode information determined and signaled by the image encoding apparatus.

Referring to FIG. 11, the image decoding apparatus may obtain intra prediction mode information from a bitstream (S1110). As described above, the intra prediction mode information may include at least one of an mpm flag, an mpm index or a remaining intra prediction mode.

The image decoding apparatus may construct an MPM list (S1120). The MPM list may be constructed to be equal to the MPM list constructed by the image encoding apparatus. That is, the MPM list may include an intra prediction mode of a neighbouring block and may further include specific intra prediction modes according to a predetermined method.

Although, in the example shown in FIG. 11, S1120 is shown as being performed after S1110, this is an example and S1120 may be performed before S1110 or they may be simultaneously performed.

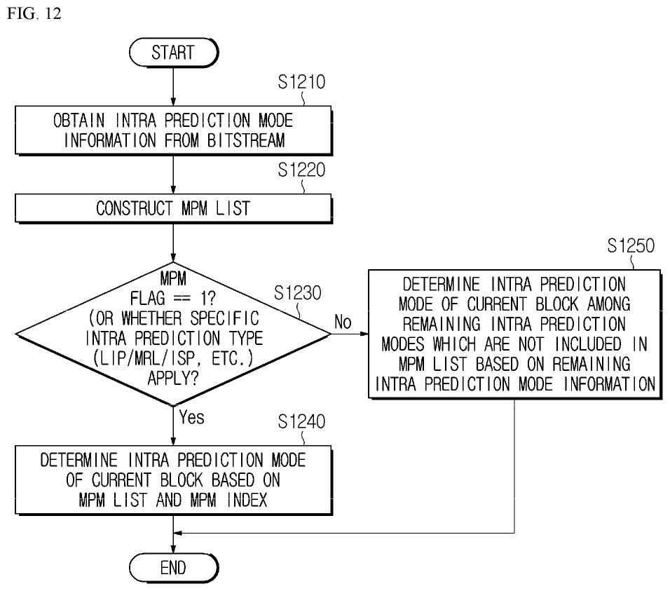

The image decoding apparatus determines the intra prediction mode of the current block based on the MPM list and the intra prediction mode information (S1130). Step S1130 will be described in greaer detail with reference to FIG. 12.

FIG. 12 is a flowchart illustrating an intra prediction mode derivation procedure in more detail.

Steps S1210 and S1220 of FIG. 12 may correspond to steps S1110 and S1120 of FIG. 11, respectively. Accordingly, a detailed description of steps S1210 and S1220 will be omitted.

The image decoding apparatus may obtain intra prediction mode information from a bitstream, construct an MPM list (S1210 and S1220), and determine a predetermined condition (S1230). Specifically, as shown in FIG. 12, when the value of an mpm flag is 1 (in S1230, Yes), the image decoding apparatus may derive a candidate indicated by the mpm index among the MPM candidates in the MPM list as the intra prediction mode of the current block (S1240). As another example, when the value of the mpm flag is 0 (in S1230, No), the image decoding apparatus may derive an intra prediction mode indicated by the remaining intra prediction mode information among remaining intra prediction modes which are not included in the MPM list as the intra prediction mode of the current block (S1250). Meanwhile, as another example, when the intra prediction type of the current block is a specific type (e.g., LIP, MRL or ISP) (in S1230, Yes), the image decoding apparatus may derive a candidate indicated by the mpm index in the MPM list as the intra prediction mode of the current block, without checking the mpm flag (S1240).

FIG. 13 is a view showing an intra prediction direction according to an embodiment of the present disclosure.

The intra prediction mode may include, for example, two non-directional intra prediction modes and 33 directional intra prediction modes. The non-directional intra prediction modes may include a planar intra prediction mode and a DC intra prediction mode, and the directional intra prediction modes may include second to 34^{th} intra prediction modes. The planar intra prediction mode may be referred to as a planar mode, and the DC intra prediction mode may be referred to as a DC mode.

In order to capture any edge direction presented in natural video, as shown in FIG. 13, the intra prediction mode may include two non-directional intra prediction modes and 65 extended directional intra prediction modes. The non-directional intra prediction modes may include a planar mode and a DC mode, and the directional intra prediction modes may include second to 66th intra prediction modes. The extended intra prediction modes are applicable to blocks having all sizes, and are applicable to both a luma component (luma block) and a chroma component (chroma block).

Alternatively, the intra prediction mode may include two non-directional intra prediction modes and 129 directional intra prediction modes. The non-directional intra prediction modes may include a planar mode and a DC mode, and the directional intra prediction modes may include second to 130th intra prediction modes.

Meanwhile, the intra prediction mode may further include a cross-component linear model (CCLM) mode for chroma samples in addition to the above-described intra prediction modes. The CCLM mode may be split into L_CCLM, T_CCLM, LT_CCLM according to whether left samples, upper samples or both thereof is considered for LM parameter derivation and may apply only to a chroma component.

For example, the intra prediction mode may be, for example, indexed as shown in Table 2 below.

TABLE 2

| Intra prediction | |
|---|---|
| mode | Associated name |
| 0 | INTRA_PLANAR |
| 1 | INTRA_DC |
| 2..66 | INTRA_ANGULAR2..INTRA_ANGULAR66 |
| 81..83 | INTRA_LT_CCLM, |
| | INTRA_L_CCLM, INTRA_T_CCLM |

FIG. 14 shows an intra prediction direction according to another embodiment of the present disclosure. In FIG. 14, a dotted-line direction shows a wide angle mode applying only to a non-square block. As shown in FIG. 14, in order to capture any edge direction presented in natural video, the intra prediction mode according to an embodiment may include two non-directional intra prediction modes and 93 directional intra prediction modes. The non-directional intra prediction modes may include a planar mode and a DC mode, and the directional intra prediction modes may include second to 80^{th} and −1^{st} to −14^{th} intra prediction modes, as denoted by arrow of FIG. 14. The planar mode may be denoted by INTRA_PLANAR, and the DC mode may be denoted by INTRA_DC. In addition, the directional intra prediction mode may be denoted by INTRA_ANGULAR-14 to INTRA_ANGULAR-1 and INTRA_ANGULAR2 to INTRA_ANGULAR80. Hereinafter, a prediction sample derivation method of a chroma component block according to the present disclosure will be described in detail.

Meanwhile, as described above, when ALWIP applies to a current block (e.g., a value of an LWIP flag or intra_lwip_flag is 1), an MPM list for ALWIP may be separately constructed and an MPM flag which may be included in the intra prediction mode information for ALWIP may be referred to as intra_lwip_mpm_flag, an MPM index may be referred to as intra_lwip_mpm_idx, and remaining intra prediction mode information may be referred to as intra_lwip_mpm_remainder.

In addition, various prediction modes may be used for ALWIP, and a matrix and an offset for ALWIP may be derived according to the intra prediction mode for ALWIP. As described above, the matrix may be referred to as an (affine) weighted matrix, and the offset may be referred to as an (affine) offset vector or an (affine) bias vector. The number of intra prediction modes for ALWIP may be set differently based on the size of the current block. For example, i) 35 intra prediction modes (that is, intra prediction modes 0 to 34) may be available when each of the height and width of the current block (e.g., CB or TB) is 4, ii) 19 intra prediction modes (that is, intra prediction modes 0 to 18) may be available when both the height and width of the current block are equal to or less than 8 and iii) 11 intra prediction modes (that is, intra prediction modes 0 to 10) may be used in the other cases. For example, when the case where each of the height and width of the current block is 4 may be referred to as block size type 0, the case where both the height and width of the current block are equal to or less than 8 may be referred to as block size type 1, and the other case may be referred to as block size type 2, the number of intra prediction modes for ALWIP may be organized as shown in Table 3. However, this is an example and the block size type and the number of available intra prediction modes may be changed.

TABLE 3

| block size type | number of ALWIP intra prediction | intra prediction |
|---|---|---|
| (sizeId) | modes | mode |
| 0 | 35 | 0...34 |
| 1 | 19 | 0...18 |
| 2 | 11 | 0...10 |

Meanwhile, an MPM list may be constructed to include N MPMs. In this case, N may be 5 or 6.

Three types of modes described below may be considered to construct the MPM list.
Default intra modes
Neighbour intra modes
Derived intra modes

For the neighbour intra modes, two neighbour blocks, that is, a left neighbour block A and a top neighbour block B, may be considered.

In addition, the following initialized default MPM may be considered to construct the MPM list.

Default 6 MPM modes={A, Planar (0) or DC (1), Vertical (50), HOR (18), VER−4 (46), VER+4 (54)}

The MPM list may be constructed by performing a pruning process for the two neighbour intra modes. When the two neighbour intra modes are equal to each other and the neighbour intra mode is greater than a DC (1) mode, the MPM list may include {A, Planar, DC} modes and include three derived intra modes. The three derived intra modes may be obtained by adding a predetermined offset value to the neighbour intra mode and/or performing a modulo operation. When the two neighbour intra modes are different from each other, the two neighbour intra modes may be assigned to a first MPM mode and a second MPM mode, and the remaining four MPM modes may be derived from the default modes and/or neighbour intra modes. In an MPM list generation process, the pruning process may be performed to prevent the same mode from overlapping in the MPM list. Truncated binary code (TBC) may be used for entropy encoding of modes other than the MPM mode.

The above-described MPM list construction method may be used when ALWIP does not apply to the current block. For example, the above-described MPM list construction method may be used to derive the intra prediction mode used in LIP, PDPC, MRL or ISP intra prediction or normal intra prediction. Meanwhile, the left neighbour block or the top neighbour block may be coded based on ALWIP. That is, ALWIP may apply when coding the left neighbour block or the top neighbour block. In this case, it is not suitable that an ALWIP intra prediction mode number of a neighbour block (left neighbour block/top neighbour block), to which ALWIP applies, is used in the MPM list for a current block, to which ALWIP does not apply, without change. Accordingly, in this case, for example, an intra prediction mode of a neighbour block (left neighbour block/top neighbour block), to which ALWIP applies, may be regarded as a DC or planar mode. That is, when the MPM list of the current block is constructed, the intra prediction mode of the neighbour block encoded in ALWIP may be replaced with a DC or planar mode. Alternatively, as another example, the intra prediction mode of a neighbour block (left neighbour block/top neighbour block), to which ALWIP applies, may be mapped to a normal intra prediction mode based on a mapping table and may be used to construct the MPM list of the current block. In this case, the mapping may be performed based on the block size type of the current block. For example, the mapping table may be shown in Table 4.

TABLE 4

| ALWIP | block size type sizeId | | |
|---|---|---|---|
| IntraPredMode[ xNbX ][ yNbX ] | 0 | 1 | 2 |
| 0 | 0 | 0 | 1 |
| 1 | 18 | 1 | 1 |
| 2 | 18 | 0 | 1 |
| 3 | 0 | 1 | 1 |
| 4 | 18 | 0 | 18 |
| 5 | 0 | 22 | 0 |
| 6 | 12 | 18 | 1 |
| 7 | 0 | 18 | 0 |
| 8 | 18 | 1 | 1 |
| 9 | 2 | 0 | 50 |
| 10 | 18 | 1 | 0 |
| 11 | 12 | 0 | |
| 12 | 18 | 1 | |
| 13 | 18 | 0 | |
| 14 | 1 | 44 | |
| 15 | 18 | 0 | |
| 16 | 18 | 50 | |
| 17 | 0 | 1 | |
| 18 | 0 | 0 | |
| 19 | 50 | | |
| 20 | 0 | | |
| 21 | 50 | | |
| 22 | 0 | | |
| 23 | 56 | | |
| 24 | 0 | | |
| 25 | 50 | | |
| 26 | 66 | | |
| 27 | 50 | | |
| 28 | 56 | | |
| 29 | 50 | | |
| 30 | 50 | | |
| 31 | 1 | | |
| 32 | 50 | | |
| 33 | 50 | | |
| 34 | 50 | | |

In Table 4 above, ALWIP IntraPredMode represents the ALWIP intra prediction mode of a neighbour block (left neighbour block/top neighbour block), and the block size type (sizeId) represents the block size type of the neighbour block or the current block. Numbers below the block size type values 0, 1 and 2 represent normal intra prediction modes to which ALWIP intra prediction modes are mapped, in case of each block size type. For example, when the block size type of the current block is 0 and the ALWIP intra prediction mode number of the neighbour block is 10, the mapped normal intra prediction mode number may be 18. However, the mapping relationship is an example and may be changed.

Meanwhile, when ALWIP applies to the current block, an MPM list for a current block, to which ALWIP applies, may be separately constructed. The MPM list may be called various names such as an ALWIP MPM list (or an LWIP MPM list or candLwipModeList) to be distinguished from the MPM list in case where ALWIP does not apply to the current block. Hereinafter, for distinguishment, this is represented by an ALWIP MPM list and may be simply referred to as an MPM list.

The ALWIP MPM list may include n candidates and n may be, for example, 3. The ALWIP MPM list may be constructed based on the left neighbour block and top neighbour block of the current block. Here, the left neighbour block may represent an uppermost block among neighbour blocks adjacent to the left boundary of the current block. In addition, the top neighbour block may represent a leftmost block among neighbour blocks adjacent to the top boundary of the current block.

For example, when ALWIP applies to the left neighbour block, a first candidate intra prediction mode (or candLwipModeA) may be set equal to the ALWIP intra prediction mode of the left neighbour block. In addition, for example, when ALWIP applies to the top neighbour block, a second candidate intra prediction mode (or candLwipModeB) may be set equal to the ALWIP intra prediction mode of the top neighbour block. Meanwhile, the left neighbour block or the top neighbour block may be coded based on intra prediction instead of ALWIP. That is, an intra prediction type other than ALWIP may apply when coding the left neighbour block or the top neighbour block. In this case, it is not suitable that a normal intra prediction mode number of a neighbour block (left neighbour block/top neighbour block), to which ALWIP does not apply, is used as a candidate intra mode for a current block, to which ALWIP applies, without change. Accordingly, in this case, for example, an ALWIP intra prediction mode of a neighbour block (left neighbour block/top neighbour block), to which ALWIP does not apply, may be regarded as an ALWIP intra prediction mode of a specific value (e.g., 0, 1 or 2). Alternatively, as another example, the normal intra prediction mode of a neighbour block (left neighbour block/top neighbour block), to which ALWIP does not apply, may be mapped to an ALWIP intra prediction mode based on a mapping table and may be used to construct the MPM list. In this case, the mapping may be performed based on the block size type of the current block. For example, the mapping table may be shown in Table 5.

TABLE 5

| | block size type sizeId | | |
|---|---|---|---|
| IntraPredModeY[ xNbX ][ yNbX ] | 0 | 1 | 2 |
| 0 | 17 | 0 | 5 |
| 1 | 17 | 0 | 1 |
| 2, 3 | 17 | 10 | 3 |
| 4, 5 | 9 | 10 | 3 |
| 6, 7 | 9 | 10 | 3 |
| 8, 9 | 9 | 10 | 3 |
| 10, 11 | 9 | 10 | 0 |
| 12, 13 | 17 | 4 | 0 |
| 14, 15 | 17 | 6 | 0 |
| 16, 17 | 17 | 7 | 4 |
| 18, 19 | 17 | 7 | 4 |
| 20, 21 | 17 | 7 | 4 |
| 22, 23 | 17 | 5 | 5 |
| 24, 25 | 17 | 5 | 1 |
| 26, 27 | 5 | 0 | 1 |
| 28, 29 | 5 | 0 | 1 |
| 30, 31 | 5 | 3 | 1 |
| 32, 33 | 5 | 3 | 1 |
| 34, 35 | 34 | 12 | 6 |
| 36, 37 | 22 | 12 | 6 |
| 38, 39 | 22 | 12 | 6 |
| 40, 41 | 22 | 12 | 6 |
| 42, 43 | 22 | 14 | 6 |
| 44, 45 | 34 | 14 | 10 |
| 46, 47 | 34 | 14 | 10 |
| 48, 49 | 34 | 16 | 9 |
| 50, 51 | 34 | 16 | 9 |
| 52, 53 | 34 | 16 | 9 |
| 54, 55 | 34 | 15 | 9 |
| 56, 57 | 34 | 13 | 9 |
| 58, 59 | 26 | 1 | 8 |
| 60, 61 | 26 | 1 | 8 |
| 62, 63 | 26 | 1 | 8 |
| 64, 65 | 26 | 1 | 8 |
| 66 | 26 | 1 | 8 |

In Table 5, IntraPredModeY represents the intra prediction mode of a neighbour block (left neighbour block/top neighbour block). Here, the intra prediction mode of the neighbour block may be an intra prediction mode for a luma component (sample), that is, a luma intra prediction mode. A block size type sizeId represents the block size type of a neighbour block or a current block. Numbers below the block size type values 0, 1 and 2 represent ALWIP intra prediction modes to which normal intra prediction modes are mapped in case of each block size type. For example, when the block size type of the current block is 0 and the normal intra prediction mode of the neighbour block is 10, the mapped ALWIP intra prediction mode number may be 9. However, the mapping relationship is an example and may be changed.

In addition, the neighbour block (e.g., left neighbour block/top neighbour block) may not be available (e.g., located outside a current picture or located outside a current tile/tile group/slice), or the ALWIP intra prediction mode of the neighbour block may not be available for the current block according to the block size type even if ALWIP applies to the neighbour block. In this case, a specific ALWIP intra prediction mode predefined for a first candidate and/or a second candidate may be used as the first candidate intra prediction mode or the second candidate intra prediction mode. In addition, a specific ALWIP intra prediction mode predefined for a third candidate may be used as a third candidate intra prediction mode.

For example, the predefined specific ALWIP intra prediction mode may be shown in Table 6.

TABLE 6

| | block size type sizeId | | |
|---|---|---|---|
| Candidate | 0 | 1 | 2 |
| First candidate intra | 17 | 34 | 5 |
| prediction mode or | | | |
| lwipMpmCand[ 0 ] | | | |
| Second candidate intra | 0 | 7 | 16 |
| prediction mode or | | | |
| lwipMpmCand[ 1 ] | | | |
| Third candidate intra | 1 | 4 | 6 |
| prediction mode or | | | |
| lwipMpmCand[ 2 ] | | | |

Based on the first candidate intra prediction mode and the second candidate intra prediction mode, the ALWIP MPM list may be constructed. For example, when the first candidate intra prediction mode and the second candidate intra prediction mode are different from each other, the first candidate intra prediction mode may be put as a 0th candidate (e.g., lwipMpmcand[0]) of the ALWIP MPM list and the second candidate intra prediction mode may be put as a first candidate (e.g., lwipMpmcand[1]) of the ALWIP MPM list. A second candidate (e.g., lwipMpmcand[2]) of the ALWIP MPM list may use the above-described predefined specific ALWIP intra prediction mode.

Alternatively, when the first candidate intra prediction mode and the second candidate intra prediction mode are equal to each other, one of the first candidate intra prediction mode and the second candidate intra prediction mode may be put as a 0th candidate (e.g., lwipMpmcand[0]) of the ALWIP MPM list, and a first candidate (e.g., lwipMpmcand[1]) of the ALWIP MPM list and a second candidate (e.g., lwipMpmcand[2]) of the ALWIP MPM list may use the above-described predefined specific ALWIP intra prediction modes.

As described above, the ALWIP intra prediction mode of the current block may be derived based on the ALWIP MPM list. In this case, as described above, an MPM flag which may be included in the intra prediction mode information for ALWIP may be referred to as intra_lwip_mpm_flag, an MPM index may be referred to as intra_lwip_mpm_idx, and remaining intra prediction mode information may be referred to as intra_lwip_mpm_remainder. A procedure of deriving an ALWIP intra prediction mode from the ALWIP MPM list may be performed as described above with reference to FIGS. 10 and 11. Alternatively, the ALWIP intra prediction mode of the current block may be directly signaled.

Affine Linear Weighted Intra Prediction (ALWIP)

Hereinafter, ALWIP according to the present disclosure will be described in detail.

ALWIP may also be referred to as matrix weighted intra prediction (MWIP) or matrix based intra prediction (MIP). In order to predict a current block having a size of W×H by applying ALWIP, one line including H reconstructed neighbouring boundary samples adjacent to the left of the current block and one line including W reconstructed neighbouring boundary samples adjacent to the top of the current block may be used as input. Unavailable reconstructed neighbouring boundary samples may be replaced with available samples according to a method performed in general intra prediction. A process of generating a prediction signal by applying ALWIP may include the following three steps.

Step 1. Averaging process: By performing averaging using neighbouring boundary samples, four sample values (in case of W=H=4) or eight sample values (in the other case) may be derived.

Step 2. Matrix vector multiplication process: By performing matrix vector multiplication with the averaged sample values as input and adding an offset, a reduced prediction signal for a subsampled set of samples in an original block may be generated.

Step 3. (linear) Interpolation process: By linearly interpolating a prediction signal for the subsampled set, a prediction signal at the remaining position may be generated. Linear interpolation may be single-step linear interpolation in each direction.

A matrix and an offset necessary to generate the prediction signal (predicted block or predicted samples) may be obtained from three matrix sets S₀, S₁ and S₂. The set S₀ may be composed of 18 matrices and 18 offset vectors. At this time, each matrix may be composed of 16 rows and four columns and the size of each offset vector may be 16. The matrices and the offset vectors of the set S₀ may be used for a block having a size of 4×4.

The set S₁ may be composed of 10 matrices and 10 offset vectors. At this time, each matrix may be composed of 16 rows and 8 columns and the size of each offset vector may be 16. The matrices and offset vectors of the set S₁ may be used for blocks having sizes of 4×8, 8×4 and 8×8.

The set S₂ may be composed of 6 matrices and 6 offset vectors. At this time, each matrix may be composed of 64 rows and 8 columns, and the size of each offset vector may be 64. The matrices and offset vectors of the set S₂ may be used for blocks having all other shapes.

The total number of multiplications required for operation of the matrix vector multiplication is always equal to or less than 4×W×H. That is, a maximum of 4 multiplications per sample is required for an ALWIP mode.

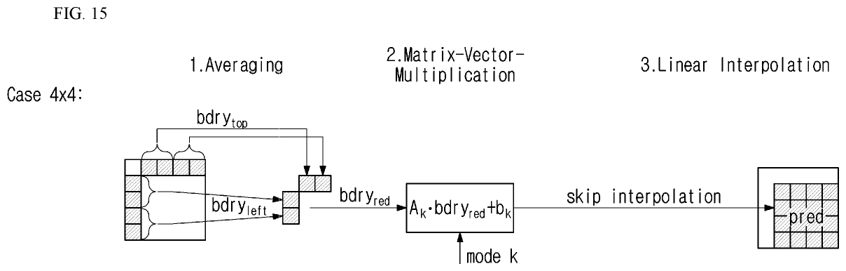

Hereinafter, an ALWIP process for the various shapes of blocks will be described with reference to FIGS. 15 to 18. Blocks other than the blocks shown in FIGS. 15 to 18 may be processed by one of the methods described with reference to FIGS. 15 to 18.

FIG. 15 is a view illustrating an ALWIP process for a 4×4 block.

First, in the averaging step, two average values may be obtained along each boundary. That is, by selecting and averaging two top neighbouring boundary samples of a current block, two average values bdryₜₒₚ may be obtained. In addition, by selecting and averaging two left neighbouring boundary samples of the current block, two average values bdry_{left} may be obtained. Thereafter, matrix vector multiplication may be performed by inputting four sample values bdry_{red} generated in the averaging step. At this time, a matrix Aₖ may be obtained from the set S₀ using an ALWIP mode (mode k). As a result of adding an offset bₖ to the result of performing matrix vector multiplication, 16 final prediction samples may be generated. In this case, linear interpolation is not required. Accordingly, a total of (4×16)/(4×4)=4 multiplications may be performed per sample.

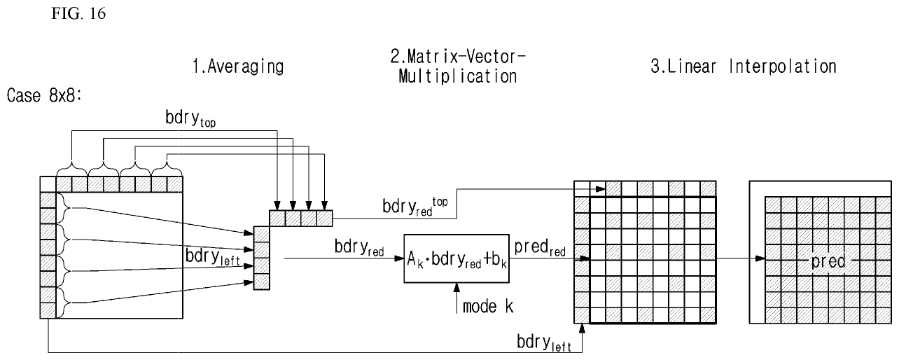

FIG. 16 is a view illustrating an ALWIP process for an 8×8 block.

First, in the averaging step, four average values may be obtained along each boundary. That is, by selecting and averaging two top neighbouring boundary samples of a current block, four average values bdryₜₒₚ may be obtained. In addition, by selecting and averaging two left neighbouring boundary samples of the current block, four average values bdry_{left} may be obtained. Thereafter, matrix vector multiplication may be performed by inputting eight sample values bdry_{red} generated in the averaging step. At this time, a matrix Aₖ may be obtained from the set S₁ using an ALWIP mode (mode k). As a result of adding an offset bₖ to the result of performing matrix vector multiplication, samples predred at 16 odd positions in a prediction block may be generated. Accordingly, a total of (8×16)/(8×8)=2 multiplications may be performed per sample. Finally, vertical interpolation may be performed using samples of predred and reduced top neighbouring boundary samples bdry_{redtop}. Thereafter, horizontal interpolation may be performed using left neighbouring boundary samples bdry_{left}. At this time, since multiplication operation is not required for interpolation, a total of 2 multiplications may be performed per sample for ALWIP prediction for an 8×8 block.

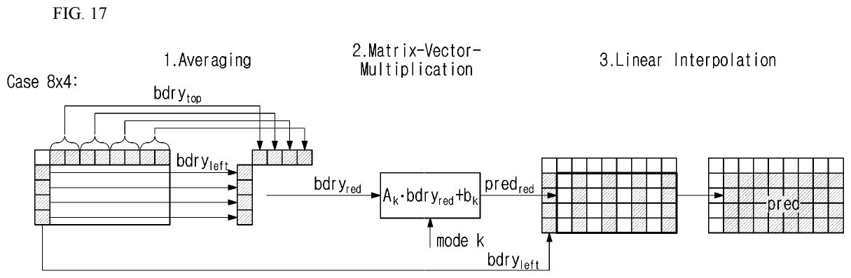

FIG. 17 is a view illustrating an ALWIP process for an 8×4 block.

First, in the averaging step, four average values may be obtained along a horizontal boundary. That is, by selecting and averaging two top neighbouring boundary samples of a current block, four average values bdryₜₒₚ may be obtained. In addition, four left neighbouring boundary samples bdry_{left} of the current block may be obtained. Thereafter, matrix vector multiplication may be performed by inputting eight sample values bdry_{red} generated in the averaging step. At this time, a matrix Aₖ may be obtained from the set S₁ using an ALWIP mode (mode k). As a result of adding an offset bₖ to the result of performing matrix vector multiplication, samples predred at 16 positions in a prediction block may be generated. 16 positions may be odd coordinates in a horizontal direction and may be positions of all coordinates in a vertical direction. Accordingly, a total of (8×16)/(8×4)=4 multiplications may be performed per sample. Finally, horizontal interpolation may be performed using samples of predred and left neighbouring boundary samples bdry_{left}. At this time, since multiplication operation is not required for interpolation, a total of 4 multiplications may be performed per sample for ALWIP prediction for an 8×4 block.

The ALWIP process for a 4×8 block may be a transposed process of a process for an 8×4 block.

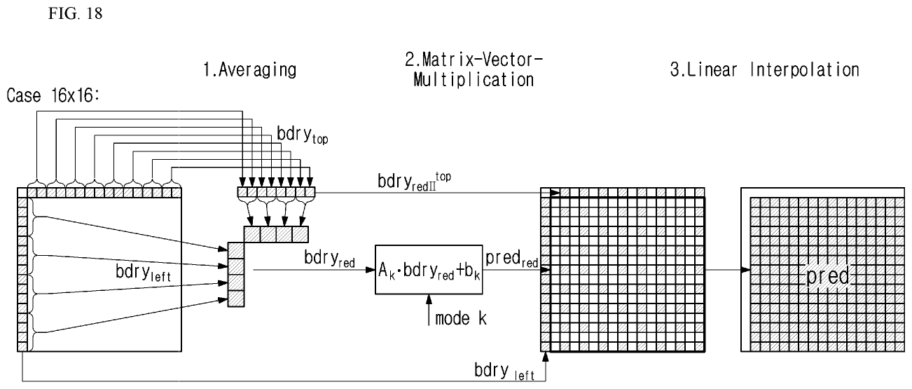

FIG. 18 is a view illustrating an ALWIP process for a 16×16 block.

First, in the averaging step, four average values may be obtained along a boundary. That is, by selecting and averaging two neighbouring boundary samples of a current block, eight average values may be obtained. In addition, by selecting and averaging two of eight sample values, four average values may be obtained. Alternatively, by selecting and averaging four neighbouring boundary samples of the current block, four average values may be obtained. Thereafter, matrix vector multiplication may be performed by inputting eight sample values bdry_{red} generated in the averaging step. At this time, a matrix Aₖ may be obtained from the set S₂ using an ALWIP mode (mode k). As a result of adding an offset bₖ to the result of performing matrix vector multiplication, samples predred at 16 odd positions in a prediction block may be generated. Accordingly, a total of (8×64)/(16×16)=2 multiplications may be performed per sample. Finally, vertical interpolation may be performed using samples of predred and reduced top neighbouring boundary samples bdry_{redII}^{top}. Thereafter, horizontal interpolation may be performed using left neighbouring boundary samples bdry_{left}. In this case, since multiplication operation is not required for interpolation, a total of 2 multiplications may be performed per sample for ALWIP prediction for a 16×16 block.

In case of W×8 block (W>8), since samples of predred are odd coordinates in a horizontal direction and are located at position of all coordinates in a vertical direction, only horizontal interpolation may be performed. In this case, in order to calculate predred, a total of (8×64)/(W×8)=64/W multiplications may be performed per sample. For example, when W is 16, additional multiplication for linear interpolation may not be performed. In addition, when W is greater than 16, the number of multiplications required per sample for linear interpolation may be less than 2. Accordingly, the total number of multiplications per sample may be equal to 4 or may be less than 4.

In case of a W×4 block (W>8), a matrix Aₖ may be generated by skipping all rows corresponding to an odd entry in a horizontal direction of the reduced block. Accordingly, predred may include 32 samples and only horizontal interpolation may be performed. In this case, in order to calculate predred, a total of (8×32)/(W×4)=64/W multiplications may be performed per sample. For example, when W is 16, additional multiplication for linear interpolation may not be performed. In addition, when W is greater than 16, the number of additional multiplications required per sample for linear interpolation may be less than 2. Accordingly, the total number of multiplications per sample may be equal to 4 or may be less than 4.

The ALWIP process for an 8×H block or a 4×H block may be a transposed process of a process for a W×8 block or a W×4 block.

Hereinafter, the averaging step will be described in detail.

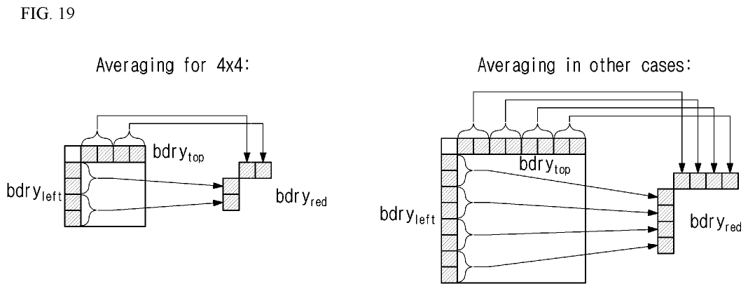

FIG. 19 is a view illustrating an averaging step of an ALWIP process according to the present disclosure.

Averaging may apply for each of the left boundary and/or top boundary of a current block. In this case, the boundary indicates neighbouring reference samples adjacent to the boundary of the current block, like gray samples shown in FIG. 19. For example, a left boundary bdry_{left} indicates left neighbouring reference samples adjacent to the left boundary of the current block. In addition, a top boundary bdryₜₒₚ indicates top neighbouring reference samples adjacent to the top boundary of the current block.

When the current block is a 4×4 block, each boundary size may be reduced to two samples based on the averaging process. When the current block is a block other than a 4×4 block, each boundary size may be reduced to four samples based on the averaging process.

First, input boundaries bdryₜₒₚ and bdry_{left} may be reduced to smaller boundaries bdry_{red}^{top} and bdry_{red}^{left}. bdry_{red}^{top} and bdry_{red}^{left} may be composed of two samples in case of a 4×4 block and may be composed of four samples in the other case.

Specifically, in case of a 4×4 block, bdry_{red}^{top} may be generated using Equation 1.

$${bdry}_{red}^{top} [ i ] = ( ( {\sum }_{j = 0}^{1} {bdry}^{top} [ i \cdot 2 + j ] ) + 1 ) \text{>>} 1 \qquad [ Equation 1 ]$$

In Equation 1, i may have a value equal to or greater than 0 and less than 2. In addition, bdry_{red}^{left} may be generated similarly to Equation 1 above.

Otherwise, when the width W of the block is 4×2^{k}, bdry_{red}^{top} may be generated using Equation 2.

$${bdry}_{red}^{top} [ i ] = ( ( {\sum }_{j = 0}^{{2}^{k} - 1} {bdry}^{top} [ i \cdot {2}^{k} + j ] ) + ( 1 \text{<<} ( k - 1 ) ) ) \text{>>} k \qquad [ Equation 2 ]$$

In Equation 2, i may have a value equal to or greater than 0 and less than 4. In addition, bdry_{red}^{left} may be generated similarly to Equation 2 above.

Two reduced boundaries bdry_{red}^{top} and bdry_{red}^{left} generated as described above may be concatenated to generate a reduced boundary vector bdry_{red}. The reduced boundary vector may have a size of 4 for a 4×4 block and may have a size of 8 for the other blocks. Equation 3 shows a method of concatenating bdry_{red}^{top} and bdry_{red}^{left} according to a mode (ALWIP mode) and a size (W, H) of a block to generate bdry_{red}.

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6. \end{matrix} \qquad [ Equation 3 ]$$

As shown in Equation 3, according to the size (W, H) of the current block and the ALWIP mode, the order of concatenating bdry_{red}^{top} and bdry_{red}^{left} may be changed. For example, when the current block is a 4×4 block and the mode is less than 18, bdry_{red} may be generated by concatenating bdry_{red}^{left} after bdry_{red}^{top}. Alternatively, for example, when the current block is a 4×4 block and the mode is equal to 18 or is greater than 18, bdry_{red} may be generated by concatenating bdry_{red}^{top} after bdry_{red}^{left}. Alternatively, the order of concatenating bdry_{red}^{top} and bdry_{red}^{left} may be determined based on information (e.g., flag information) signaled through a bitstream.

Finally, an averaged boundary of a second version is necessary to perform interpolation of a subsampled prediction signal with respect to a block having a large size. That is, when min(W, H)>8 and W>=H, W=8×2¹. In this case, an averaged boundary bdry_{redII}^{top} of the second version may be generated using Equation 4.

$${bdry}_{redII}^{top} [ i ] = ( ( {\sum }_{j = 0}^{{2}^{l} - 1} {bdry}^{top} [ i \cdot {2}^{l} + j ] ) + ( 1 \text{<<} ( l - 1 ) ) ) \text{>>} l \qquad [ Equation 4 ]$$

In Equation 4 above, i may have a value equal to or greater than 0 and less than 8. In addition, when min(W, H)>8 and W<H, bdry_{redII}^{left} may be generated similarly to Equation 4 above.

Hereinafter, a step of generating a reduced prediction signal by performing matrix vector multiplication will be described in detail.

Using bdry_{red} generated in the averaging step, a reduced prediction signal predred may be generated. The reduced prediction signal predred may be a signal of a downsampled block having a size of W_{red}×H_{red}. In this case, W_{red} and H_{red} may be defined as shown in Equation 5.

$${W}_{red} = \{ \begin{matrix}4 & for max ( W , H ) \leq 8 \\ min ( W , 8 ) & for max ( W , H ) > 8\end{matrix} \\ {H}_{red} = \{ \begin{matrix}4 & for max ( W , H ) \leq 8 \\ min ( H , 8 ) & for max ( W , H ) > 8\end{matrix} \qquad [ Equation 5 ]$$

The reduced prediction signal predred may be generated by matrix vector multiplication and addition of an offset as shown in Equation 6.

pred_{red}=A·bdry_{red}+b. [Equation 6]

In Equation 6, A may be a matrix composed of W_{red}×H_{red} rows and four columns (when the current block is a 4×4 block) or eight columns (in the other case). The offset vector b may be a vector having a size of W_{red}×H_{red}.

The matrix A and the offset vector b may be obtained from matrix sets S₀, S₁ and S₂ as follows.

First, an index idx may be set to idx(W, H) according to Equation 7. That is, idx may be set based on the width W and height H of the current block.

$$idx ( W , H ) = \{ \begin{matrix}0 & for W = H = 4 \\ 1 & for max ( W , H ) = 8 \\ 2 & for max ( W , H ) > 8.\end{matrix} \qquad [ Equation 7 ]$$

In addition, according to Equation 8, a variable m may be set based on an ALWIP mode and the width W and height H of the current block according to Equation 8.

$$m = \{ \begin{matrix}mode & for W = H = 4 and mode \geq 18 \\ mode - 17 & for W = H = 4 and mode \geq 18 \\ mode & for max ( W , H ) = 8 and mode \geq 10 \\ mode - 9 & for max ( W , H ) = 8 and mode \geq 10 \\ mode & for max ( W , H ) > 8 and mode \geq 6 \\ mode - 5 & for max ( W , H ) > 8 and mode \geq 6. \end{matrix} \qquad [ Equation 8 ]$$

When the index idx is equal to or less than 1 or when the index idx is 2 and min(W, H) is greater than 4, the matrix A may be determined to be A_{idx}^{m} and the offset vector b may be determined to be b_{idx}^{m}. When the index idx is 2 and min(W, H) is 4, the matrix A may be generated by skipping all rows corresponding to odd x coordinates in the downsampled block in A_{idx}^{m}, when W is 4, and may be generated by skipping all rows corresponding to odd y coordinates in a downsampled block in A_{idx}^{m}, when H is 4.

Finally, in case of Equation 9 below, the reduced prediction signal may have reversed rows and columns.

W=H=4 and mode≥18

max(W,H)=8 and mode≥10

max(W,H)>8 and mode≥6 [Equation 9]

In case of W=H=4, since the matrix A has four columns and 16 rows, the number of multiplications required to calculate the reduced prediction signal predred is 4. In all other cases, since the matrix A has eight columns and W_{red}×H_{red} rows, 8×W_{red}×H_{red}<=4×W×H multiplications are required. That is, in this case, a maximum of four multiplications may be performed per sample.

Hereinafter, a linear interpolation step will be described in detail.

The interpolation process may be referred to as a linear or bilinear interpolation process. The interpolation may include two steps including vertical interpolation and horizontal interpolation.

In case of W>=H, vertical interpolation may be first performed and then horizontal interpolation may be performed. In case of W<H, horizontal interpolation may be first performed and then vertical interpolation may be performed. In case of a 4×4 block, an interpolation process may be skipped.

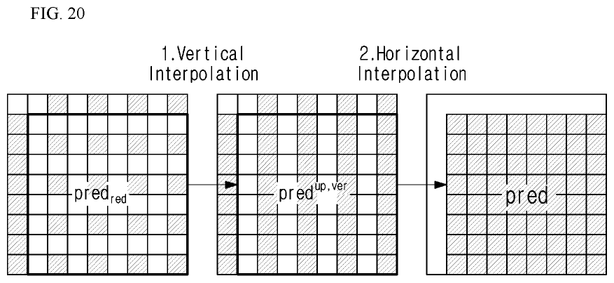

FIG. 20 is a view illustrating an interpolation step of an ALWIP process according to the present disclosure.

In case of a W×H block with Max(W, H)>=8, a prediction signal may be generated by linearly interpolating a reduced prediction signal predred (W_{red}λH_{red}). Depending on the shape of the block, linear interpolation may be performed in a vertical direction, a horizontal direction or in both directions. When linear interpolation is performed in both directions, linear interpolation may be first performed in a horizontal direction in case of W<H and, otherwise, may be first performed in a vertical direction. As shown in FIG. 20, for example, in case of an 8×8 block, vertical interpolation may be first performed and then horizontal interpolation may be performed, thereby generating a final prediction signal pred.

Hereinafter, in case of a W×H block with Max(W, H)>=8 and W>=H, vertical linear interpolation will be described as one-dimensional linear interpolation. However, the following description is adaptively applicable to horizontal linear interpolation. That is, although only vertical linear interpolation is described to avoid a repeated description, the following description is applicable to horizontal linear interpolation. First, the reduced prediction signal may extend to a top boundary based on a boundary signal. When a vertical upsampling factor is defined as Uᵥₑᵣ=H/H_{red}, Uᵥₑᵣ may be expressed as 2^{uver}. The extended reduced prediction signal may be generated by Equation 10.

$${pred}_{red} [ x ] [ - 1 ] = \{ \begin{matrix}{bdry}_{red}^{top} [ x ] & for W = 8 \\ {bdry}_{redII}^{top} [ x ] & for W > 8\end{matrix} \qquad [ Equation 10 ]$$

From the extended reduced prediction signal, using Equation 11, by performing vertical linear prediction, a vertically interpolated prediction signal may be generated.

$${pred}_{red}^{ups , ver} [ x ] [ {U}_{ver} \cdot y + k ] = ( ( {U}_{ver} - k - 1 ) \cdot {pred}_{red} [ x ] [ y - 1 ] + ( k + 1 ) \cdot {pred}_{red} [ x ] [ y ] + \frac{{U}_{ver}}{2} ) \text{>>} {u}_{ver} \\ for 0 \leq x < {W}_{red} , 0 \leq y < {H}_{red} and 0 \leq k < {U}_{ver} \qquad [ Equation 11 ]$$

Horizontal linear interpolation may be performed similarly to vertical linear interpolation. In this case, a row and a column, and an x coordinate and a y coordinate may be reversed. In addition, extended reduced prediction signal may be obtained by extending a reduced prediction signal to a left boundary.

As described above, by vertical linear interpolation and/or horizontal linear interpolation, a prediction signal of a current block may be finally generated.

Hereinafter, transform/inverse transform of a residual signal according to the present disclosure will be described in detail.

As described above, an image encoding apparatus may derive a residual block (residual samples) based on a block (prediction samples) predicted through intra/inter/IBC prediction and apply transform and quantization to the derived residual samples to derive quantized transform coefficients. Information (residual information) on the quantized transform coefficients may be included in a residual coding syntax and output in the form of a bitstream after encoding. An image decoding apparatus may obtain information (residual information) on the quantized transform coefficients from the bitstream and derive the quantized transform coefficient by decoding. The image decoding apparatus may derive residual samples through dequantization/inverse transform based on the quantized transform coefficients. As described above, at least one of quantization/dequantization and/or transform/inverse transform may be skipped. When transform/inverse transform is skipped, the transform coefficient may be referred to as a coefficient or a residual coefficient or may still be referred to as a transform coefficient for uniformity of expression. Whether transform/inverse transform is skipped may be signaled based on transform_skip_flag.

Transform/inverse transform may be performed by transform kernel(s). For example, according to the present disclosure, a multiple transform selection (MTS) scheme is applicable. In this case, some of a plurality of transform kernel sets may be selected and applied to a current block. The transform kernel may be referred to as various terms such as a transform matrix or a transform type. For example, the transform kernel set may represent a combination of a vertical transform kernel (vertical transform kernel) and a horizontal transform kernel (horizontal transform kernel). For example, MTS index information (e.g., tu_mts_idx syntax element) may be generated/encoded by the image encoding apparatus and signaled to the image decoding apparatus to specify one of the transform kernel sets. For example, a transform kernel set according to a value of MTS index information may be shown in Table 7.

TABLE 7

| tu_mts_idx[ x0 ][ y0 ] | 0 | 1 | 2 | 3 | 4 |
|---|---|---|---|---|---|
| trTypeHor | 0 | 1 | 2 | 1 | 2 |
| trTypeVer | 0 | 1 | 1 | 2 | 2 |

In Table 7, tu_mts_idx denotes MTS index information, and trTypeHor and trTypeVer respectively denote a horizontal transform kernel and a vertical transform kernel.

The transform kernel set may be, for example, determined based on cu_sbt_horizontal_flag and cu_sbt_pos_flag. cu_sbt_horizontal_flag may specify that the current block is partitioned into two transform blocks in a horizontal direction when having a value of 1 and specify that the current block is partitioned into two transform blocks in a vertical direction when having a value of 0. cu_sbt_pos_flag may specify that tu_cbf_luma, tu_cbf_cb and tu_cbf_cr for a first transform block of a current block are not present in a bitstream when having a value of 1 and may specify tu_cbf_luma, tu_cbf_cb and tu_cbf_cr for a second transform block of a current block are not present in a bitstream when having a value of 0. tu_cbf_luma, tu_cbf_cb and tu_cbf_cr may be syntax elements specifying whether transform blocks of corresponding color components include at least one non-zero transform coefficient. For example, when tu_cbf_luma has a value of 1, it may specify that a corresponding luma transform block includes at least one non-zero transform coefficient. As described above, trTypeHor and trTypeVer may be determined based on cu_sbt_horizontal_flag and cu_sbt_pos_flag according to Table 8 below.

TABLE 8

| cu sbt horizontal flag | cu sbt pos flag | trTypeHor | trTypeVer |
|---|---|---|---|
| 0 | 0 | 2 | 1 |
| 0 | 1 | 1 | 1 |
| 1 | 0 | 1 | 2 |
| 1 | 1 | 1 | 1 |

In Table 8, for example, when cu_sbt_horizontal_flag is 0 and cu_sbt_pos_flag is 1, each of trTpeHor and trTypeVer may be determined to be 1. The transform kernel set may be, for example, determined based on the intra prediction mode for the current block.

In the present disclosure, the MTS based transform may apply to primary transform and additionally apply to secondary transform. The secondary transform may apply only for coefficients of a top-left w×h region of a coefficient block to which the primary transform applies, and may be referred to as reduced secondary transform (RST). For example, w and/or h may be 4 or 8. In transform, the primary transform and the second transform may sequentially apply to a residual block and, in inverse transform, inverse secondary transform and inverse primary transform may sequentially apply to transform coefficients. The secondary transform (RST transform) may be referred to as low frequency coefficients transform (LFC transform or LFCT). The inverse secondary transform may be referred to as inverse LFC transform or inverse LFCT.

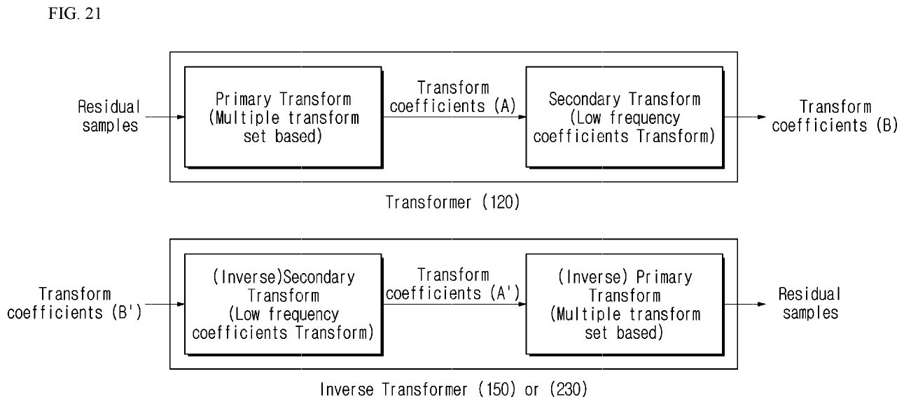

FIG. 21 is a view illustrating a transform method applying to a residual block.

As shown in FIG. 21, the transformer 120 of the image encoding apparatus may receive residual samples, perform primary transform to generate transform coefficients A, and perform secondary transform to generate transform coefficients B. The inverse transformer 150 of the image encoding apparatus and the inverse transformer 230 of the image decoding apparatus may receive transform coefficients B, perform inverse secondary transform to generate transform coefficients A, and perform inverse primary transform to generate residual samples. As described above, primary transform and inverse primary transform may be performed based on MTS. In addition, secondary transform and inverse secondary transform may be performed only with respect to a low frequency region (top-left w×h region of a block).

The transform/inverse transform may be performed in units of CU (coding units) or TU (transform units). That is, the transform/inverse transform may apply for residual samples in a CU or residual samples in a TU. A CU size and a TU size may be the same or a plurality of TUs may be present in a CU region. Meanwhile, the CU size may generally represent a luma component (sample) coding block (CB) size. The TU size may generally represent a luma component (sample) transform block (TB) size. The chroma component (sample) CB or TB size may be derived based on the luma component (sample) CB or TB size according to a component ratio according to a color format (chroma format, e.g., 4:4:4, 4:2:2, 4:2:0, etc.). The TU size may be derived based on maxTbSize. In this case, maxTbSize may mean a maximum size capable of transform. For example, when the CU size is greater than maxTbSize, a plurality of TUs (TBs) having maxTbSize may be derived from the CU, and transform/inverse transform may be performed in units of TUs (TBs). The maxTbSize may be considered in determining whether to apply various intra prediction types, such as ISP. Information on the maxTbSize may be predetermined or may be generated and encoded by the image encoding apparatus and signaled to the image decoding apparatus.

Hereinafter, secondary transform/inverse transform will be described in greater detail.

The secondary transform of the present disclosure may be mode-dependent non-separable secondary transform (MDNSST). In order to reduce complexity, MDNSST may apply only for coefficients of a low frequency region after performing primary transform. When both the width W and height H of a current transform coefficient block are equal to or greater than 8, 8×8 non-separable secondary transform may apply for a top-left 8×8 region of the current transform coefficient block. Otherwise, when W or H is less than 8, 4×4 non-separable secondary transform may apply for a top-left min(8, W)×min(8, H) region of the current transform coefficient block. A total of 35×3 non-separable secondary transform is available for a 4×4 block and an 8×8 block. Here, 35 is the number of transform sets specified by an intra prediction mode, and 3 is the number of NSST candidates (candidate kernels) for each intra prediction mode. A mapping relationship between the intra prediction mode and the corresponding transform set may be, for example, shown in Table 9.

TABLE 9

| | | | | | | | | | | | | | | | | | |
|---|---|---|---|---|---|---|---|---|---|---|---|---|---|---|---|---|---|
| intra | 0 | 1 | 2 | 3 | 4 | 5 | 6 | 7 | 8 | 9 | 10 | 11 | 12 | 13 | 14 | 15 | 16 |
| mode | | | | | | | | | | | | | | | | | |
| set | 0 | 1 | 2 | 3 | 4 | 5 | 6 | 7 | 8 | 9 | 10 | 11 | 12 | 13 | 14 | 15 | 16 |
| intra | 17 | 18 | 19 | 20 | 21 | 22 | 23 | 24 | 25 | 26 | 27 | 28 | 29 | 30 | 31 | 32 | 33 |
| mode | | | | | | | | | | | | | | | | | |
| set | 17 | 18 | 19 | 20 | 21 | 22 | 23 | 24 | 25 | 26 | 27 | 28 | 29 | 30 | 31 | 32 | 33 |
| intra | 34 | 35 | 36 | 37 | 38 | 39 | 40 | 41 | 42 | 43 | 44 | 45 | 46 | 47 | 48 | 49 | 50 |
| mode | | | | | | | | | | | | | | | | | |
| set | 34 | 33 | 32 | 31 | 30 | 29 | 28 | 27 | 26 | 25 | 24 | 23 | 22 | 21 | 20 | 19 | 18 |
| intra | 51 | 52 | 53 | 54 | 55 | 56 | 57 | 58 | 59 | 60 | 61 | 62 | 63 | 64 | 65 | 66 | 67(LM) |
| mode | | | | | | | | | | | | | | | | | |
| set | 17 | 16 | 15 | 14 | 13 | 12 | 11 | 10 | 9 | 8 | 7 | 6 | 5 | 4 | 3 | 2 | NULL |

In Table 9, for example, when an intra prediction mode is 0, a transform set for secondary transform (inverse transform) may be Set 0. When the transform set is determined based on the intra prediction mode, it is necessary to specify one of a plurality of transform kernels included in the transform set. To this end, an index (NSST Idx) may be encoded and signaled. When secondary transform/inverse transform is not performed with respect to the current transform block, NSST Idx having a value of 0 may be signaled. In addition, MDNSST may not apply for a transform-skipped block. When NSST Idx having a non-zero value is signaled for a current CU, MDNSST may not apply for a block of a transform-skipped component in a current CU. When transform is skipped for blocks of all components in the current CU or when the number of non-zero coefficients of a block subjected to transform is less than 2, NSST Idx may not be signaled for the current CU. When NSST Idx is not signaled, the value thereof may be inferred to be 0.

NSST may not apply for all blocks (TU in case of HEVC) to which primary transform applies, but may apply for a top-left 8×8 or 4×4 region. For example, 8×8 NSST may apply when the size of the block is equal to or greater than 8×8 and 4×4 NSST may apply when the size of the block is less 8×8. In addition, when applying 8×8 NSST, after dividing into 4×4 blocks, 4×4 NSST may apply for each 4×4 block. Both 8×8 NSST and 4×4 NSST follow the configuration of the above-described transform set, and, as it is non-separable transform, 8×8 NSST has 64 input data and 64 output data, and 4×4 NSST has 16 inputs and 16 outputs.

In the present disclosure, NSST/RT/RST may be referred to as low frequency non-separable transform (LFNST). LFNST may apply in a non-separable transform format based on a transform kernel (transform matrix or transform matrix kernel) for low frequency transform coefficients located in a top-left region of a transform coefficient block. The NSST index or (R)ST index may be referred to as an LFNST index.

According to an embodiment of the present disclosure, for a block to which MIP technology applies, an index (NSST idx or st_idx syntax) for LFNST may be transmitted in the same manner as before. That is, an index for specifying one of transform kernels configuring an LFNST transform set for a current block to which MIP applies may be transmitted.

According to the present disclosure, since an optimal LFNST kernel may be selected for an intra prediction block to which MIP applies, encoding efficiency may be maximized in simultaneously applying two technologies. Table 10 shows the syntax of a CU according to an embodiment of the present disclosure.

TABLE 10

| coding_unint( x0, y0, cbWidth, cbHeight, treeType ) { | Descriptor |
|---|---|
| ... | |
| if( treeType = = SINGLE_TREE \|\| treeType = = | |
| DUAL_TREE_LUMA ) { | |
| if( Abs( Log2( cbWidth ) − Log2( cbHeight ) ) <=2 ) | |
| intra_mip_flag[ x0 ][ y0 ] | ae(v) |
| if( intra_mip_flag[ x0 ][ y0 ] ) { | |
| intra_mip_mpm_flag[ x0 ][ y0 ] | ae(v) |
| if( intra_mip_mpm_flag[ x0 ][ y0 ] ) | |
| intra_mip_mpm_idx[ x0 ][ y0 ] | ae(v) |
| Else | |
| intra_mip_mpm_remainder[ x0 ][ y0 ] | ae(v) |
| } else { | |
| ... | |
| if( Min( cbWidth, cbHeight ) >= 4 && | |
| sps_st_enabled_flag = = 1 && | |
| CuPredMode[ x0 ][ y0 ] = = MODE_INTRA | |
| && IntraSubPartitionsSplitType = = | |
| ISP_NO_SPLIT ) { | |
| if( ( numSigCoeff > ( ( treeType = = SINGLE_TREE ) | |
| ? 2 : 1 ) ) && | |
| numZeroOutSigCoeff = = 0) { | |
| st_idx[ x0][ y0 ] | ae(v) |
| ... | |

In Table 10, intra_mip_flag[x0][y0] may specify that MIP applies for luma samples of a current CU when having a value of 1 and specify that MIP does not apply when having a value of 0. When intra_mip_flag[x0][y0] is not present in a bitstream, the value thereof may be inferred to be 0.

Syntax elements intra_mip_mpm_flag[x0] [y0], intra_mip_mpm_idx[x0] [y0] and intra_mip_mpm_remainder[x0][y0] of Table 10 may be used to specify MIP modes for luma samples. In addition, when the top-left position of a current picture is (0, 0), coordinates (x0, y0) may be top-left positions of the luma samples of a current coding block. When intra_mip_mpm_flag[x0] [y0] has a value of 1, it may specify that an MIP mode is derived from an intra-predicted neighbouring CU of a current CU. When intra_mip_mpm_flag[x0] [y0] is not present in a bitstream, the value thereof may be inferred to be 1.

In Table 10, st_idx[x0] [y0] may specify transform kernels (LFNST kernels) applying to LFNST for a current block. That is, st_idx may specify one of transform kernels included in an LFNST transform set. As described above, the LFNST transform set may be determined based on an intra prediction mode and block size of a current block. In the present disclosure, st_idx may be referred to as lfnst_idx.

MIP technology uses a different number of MIP modes according to the block size. For example, when cbWidth and cbHeight represent the width and height of the current block, a variable sizeId for discriminating the block size may be derived as follows.

When both cbWidth and cbHeight are 4, sizeId may be set to 0. Otherwise, when both cbWidth and cbHeight are equal to or less than 8, sizeId may be set to 1. In all other cases, sizeId may be set to 2. For example, when the current block is 16×16, sizeId may be set to 2.

The number of MIP modes available according to the sizeId is shown in Table 11.

TABLE 11

| sizeId | numModes |
|---|---|
| 0 | 35 |
| 1 | 19 |
| 2 | 11 |

That is, in MIP technology, a minimum of 11 MIP modes and a maximum of 35 MIP modes may be used. In contrast, as shown in FIG. 13, existing intra prediction may use 67 modes.

In addition, LFNST technology may determine a transform set (lfnstSetIdx) based on 67 intra prediction modes (lfnstPredModelntra) with reference to Table 12.

TABLE 12

| lfnstPredModeIntra | lfnstSetIdx |
|---|---|
| lfnstPredModeIntra < 0 | 1 |
| 0 <= lfnstPredModeIntra <= 1 | 0 |
| 2 <= lfnstPredModeIntra <= 12 | 1 |
| 13 <= lfnstPredModeIntra <= 23 | 2 |
| 24 <= lfnstPredModeIntra <= 44 | 3 |
| 45 <= lfnstPredModeIntra <= 55 | 2 |
| 56 <= lfnstPredModeIntra <= 80 | 1 |
| 81 <= lfnstPredModeIntra <= 83 | 0 |

lfnstPredModelntra of Table 12 is a mode derived based on the intra prediction mode of the current block and includes a wide-angle mode and CCLM modes described with reference to FIG. 14. Accordingly, lfnstPredModelntra of Table 12 may have a value of 0 to 83.

According to the present disclosure, when MIP technology is used in the current block, the MIP mode may be transformed into an existing intra prediction mode (the mode described with reference to FIGS. 13 and 14) to determine the index of the transform set of LFNST. Specifically, based on the MIP mode and block size (sizeId) of the current block, an intra prediction mode for determining the index of the transform set may be determined with reference to Table 13.

TABLE 13

| | sizeId | | |
|---|---|---|---|
| MIP mode | 0 | 1 | 2 |
| 0 | 0 | 0 | 1 |
| 1 | 18 | 1 | 1 |
| 2 | 18 | 0 | 1 |
| 3 | 0 | 1 | 1 |
| 4 | 18 | 0 | 18 |
| 5 | 0 | 22 | 0 |
| 6 | 12 | 18 | 1 |
| 7 | 0 | 18 | 0 |
| 8 | 18 | 1 | 1 |
| 9 | 2 | 0 | 50 |
| 10 | 18 | 1 | 0 |
| 11 | 12 | 0 | |
| 12 | 18 | 1 | |
| 13 | 18 | 0 | |
| 14 | 1 | 44 | |
| 15 | 18 | 0 | |
| 16 | 18 | 50 | |
| 17 | 0 | 1 | |
| 18 | 0 | 0 | |
| 19 | 50 | | |
| 20 | 0 | | |
| 21 | 50 | | |
| 22 | 0 | | |
| 23 | 56 | | |
| 24 | 0 | | |
| 25 | 50 | | |
| 26 | 66 | | |
| 27 | 50 | | |
| 28 | 56 | | |
| 29 | 50 | | |
| 30 | 50 | | |
| 31 | 1 | | |
| 32 | 50 | | |
| 33 | 50 | | |
| 34 | 50 | | |

In Table 13, the MIP mode represents the MIP mode of the current block and sizeId represents the size type of the current block. In addition, each number below sizeId 0, 1 and 2 represent a normal intra prediction mode (for example, one of 67 normal intra prediction modes) mapped to the MIP mode for each block size type. However, the mapping relationship is an example and may be changed.

For example, when sizeId is 0 and the MIP mode of the current block is 10, a mapped normal intra prediction mode number may be 18. In this case, for example, lfnstSetIdx may have a value of 2 according to Table 12, and, based on this, an LFNST transform set may be determined. That is, an LFNST transform set having a value of 2 may be selected, and a transform kernel specified by st_idx (or lfnst_idx) among transform kernels included in a corresponding transform set may be used for secondary transform/inverse transform of the current block.

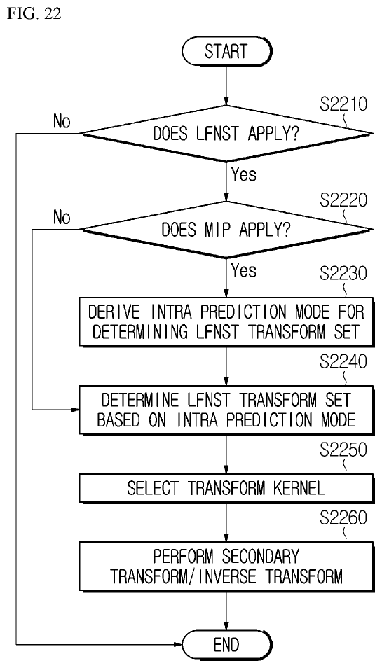

FIG. 22 is a flowchart illustrating a method of performing a secondary transform/inverse transform according to the present disclosure.

An image encoding apparatus may perform secondary transform with respect to a transform coefficient generated by performing primary transform according to the order shown in FIG. 22. An image decoding apparatus may perform inverse secondary transform with respect to transform coefficients reconstructed from a bitstream according to the order shown in FIG. 22.

First, it may be determined whether LFNST applies to a current transform block (S2210). Whether to apply LFNST may be determined, for example, based on st_idx or lfnst_idx(NSST idx) reconstructed from a bitstream. When LFNST does not apply, secondary transform/inverse transform may not be performed with respect to the current transform block. When applying LFNST, it may be determined whether MIP applies to the current block (S2220). Whether MIP applies to the current block may be determined the above-described flag information (e.g., intra_mip_flag). When applying MIP to the current block, an intra prediction mode for determining an LFNST transform set may be derived (S2230). For example, the intra prediction mode for determining the LFNST transform set may be derived based on the MIP mode. The MIP mode may be reconstructed based on information signaled through a bitstream as described above. Derivation of the intra prediction mode based on the MIP mode may be performed a method preset by the image encoding apparatus and the image decoding apparatus. For example, as described with reference to Table 13, step S2230 may be performed using the mapping table between the MIP mode and the intra prediction mode. However, it is not limited to the above method and, for example, when applying MIP, the intra prediction mode (e.g., a planar mode) may be derived as a predefined intra prediction mode to determine an LFNST transform set. After performing step S2230, the LFNST transform set may be determined based on the derived intra prediction mode (S2240). In step S2220, when the MIP mode does not apply, the intra prediction mode of the current block may be used to determine the LFNST transform set (S2240). Step S2240 may correspond to the process of determining lfnstSetIdx described with reference to Table 12. Thereafter, a transform kernel to be used for secondary transform/inverse transform of the current transform block may be selected from among a plurality of transform kernels included in the LFNST transform set (S2250). Selection of the transform kernel may be performed, for example, based on st_idx or lfnst_idx reconstructed from the bitstream. Finally, secondary transform/inverse transform may be performed with respect to the current transform block using the selected transform kernel (S2260). The image encoding apparatus may determine an optimal mode by comparison of rate-distortion costs. Accordingly, the image encoding apparatus may use the above-described flag information for determination of step S2210 or step S2220, but is not limited thereto. The image decoding apparatus may perform determination of step S2210 or step S2220 based on information signaled through the bitstream from the image encoding apparatus.

According to an embodiment of the present disclosure described with reference to FIG. 22, when LFNST applies to a block to which MIP applies, since an intra prediction mode for determining an LFNST transform set may be derived, more efficient LFNST may be performed.

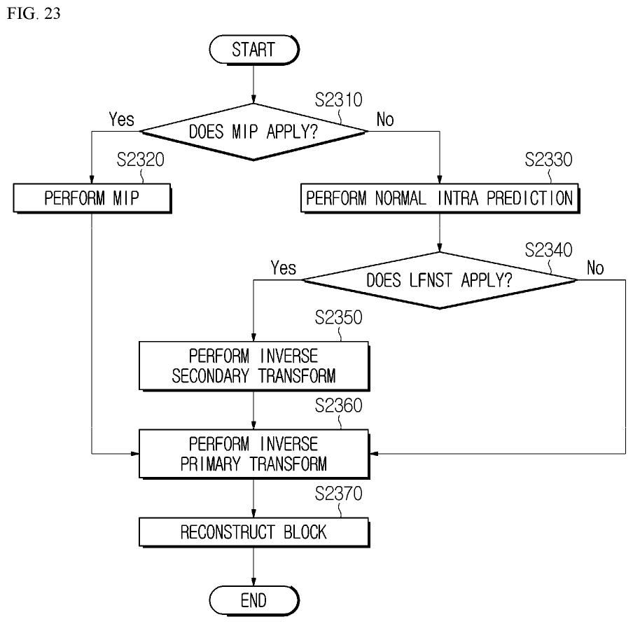

FIG. 23 is a view illustrating a method performed by an image decoding apparatus based on whether to apply MIP and LFNST according to another embodiment of the present disclosure.

According to the embodiment shown in FIG. 23, for a block to which MIP technology applies, an index (st_idx or lfnst_idx) for LFNST may not be transmitted. That is, when MIP applies to a current block, an LFNST index is inferred to be a value of 0, which may mean that LFNST technology does not apply to the current block.

First, it may be determined whether MIP applies to the current block (S2310). Whether MIP applies to the current block may be determined using the above-described flag information (e.g., intra_mip_flag). When MIP applies to the current block, MIP prediction may be performed (S2320), and it may be determined that LFNST does not apply. Accordingly, inverse secondary transform may not be performed and inverse primary transform may be performed with respect to a transform coefficient (S2360). Thereafter, the current block may be reconstructed based on a prediction block generated by applying MIP and a residual block generated by inverse transform (S2370). When MIP does not apply to the current block, normal intra prediction may be performed with respect to the current block (S2330). In addition, it may be determined whether LFNST applies to the current block (S2340). Determination of step S2340 may be made based on st_idx or lfnst_idx (NSST idx) reconstructed from a bitstream. For example, when st_idx is 0, LFNST does not apply, and, when st_idx is greater than 0, it may be determined that LFNST applies. When LFNST does not apply, inverse secondary transform may not be performed with respect to the current transform block and inverse primary transform may be performed with respect to the transform coefficient (S2360). Thereafter, the current block may be reconstructed based on a prediction block generated by normal intra prediction and a residual block generated by inverse transform (S2370). When LFNST applies to the current block, after inverse secondary transform is performed with respect to the transform coefficient (S2350), inverse primary transform may be performed (S2360). Thereafter, the current block may be reconstructed based on a prediction block generated by normal intra prediction and a residual block generated inverse transform (S2370). In this case, after an LFNST transform set is determined based on an intra prediction mode and a transform kernel to be used for inverse secondary transform is selected based on st_idx, inverse secondary transform of step S2350 may be performed based on the selected transform kernel.

Table 14 shows a syntax of a CU according to the embodiment shown in FIG. 23.

TABLE 14

| | |
|---|---|
| ... | |
| if( Min( cbWidth, cbHeight ) >= 4 && | |
| sps_st_enabled_flag = = 1 && | |
| CuPredMode[ x0 ][ y0 ] = = MODE_INTRA | |
| && IntraSubPartitionsSplitType = = ISP_NO_SPLIT | |
| && !intra_mip_flag [ x0 ][ y0 ] ) { | |
| if( ( numSigCoeff > ( ( treeType = = SINGLE_TREE ) ? | |
| 2 : 1 ) ) && | |
| numZeroOutSigCoeff = = 0) { | |
| st_idx[ x0 ][ y0 ] | ae(v) |
| } | |

As shown in Table 14, st_idx may be included only when intra_mip_flag is 0. Accordingly, when intra_mip_flag is 1, that is, when MIP applies to the current block, st_idx is not included in the bitstream. When st_idx is not present in the bitstream, the value thereof may be inferred to be 0 and thus it may be determined that LFNST does not apply to the current block.

According to the embodiment shown in FIG. 23, since an LFNST index is not transmitted for the block to which MIP applies, it may have an effect of reducing the amount of bits for encoding the corresponding index. In addition, it is possible to reduce complexity and to obtain a latency reduction effect, by preventing simultaneous application of MIP and LFNST in an image encoding apparatus and an image decoding apparatus.

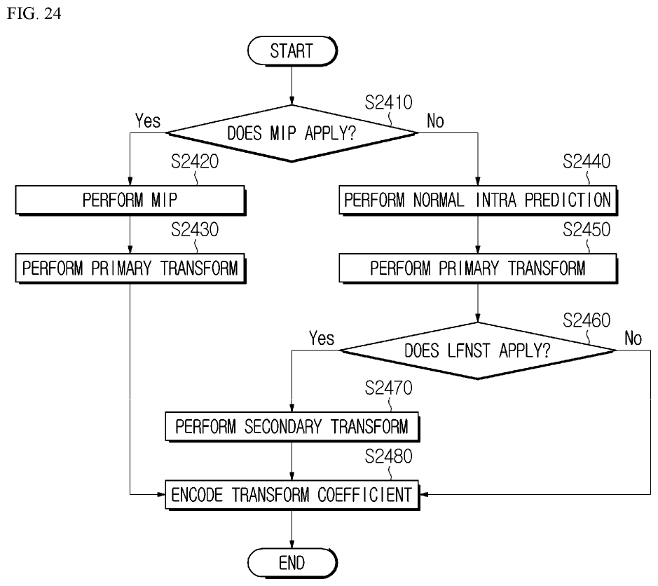

FIG. 24 is a view illustrating a method performed by an image encoding apparatus based on whether to apply MIP and LFNST according to another embodiment of the present disclosure.

The encoding method shown in FIG. 24 may correspond to the decoding method shown in FIG. 23.

First, it may be determined whether MIP applies to a current block (S2410). Whether MIP applies to the current block may be determined using the above-described flag information (e.g., intra_mip_flag). However, without being limited thereto, an image encoding apparatus may perform step S2410 using various methods. When MIP applies to the current block, MIP may be performed (S2420), and it may be determined that LFNST does not apply. Accordingly, without performing secondary transform, a residual block of the current block may be generated based on a prediction block generated by performing MIP and primary transform may be performed with respect to the residual block of the current block (S2430). Thereafter, the transform coefficient generated by transform may be encoded into a bitstream (S2480). When MIP does not apply to the current block, normal intra prediction may be performed with respect to the current block (S2440). A residual block of the current block may be generated based on a prediction block generated by performing normal intra prediction, and primary transform may be performed with respect to the generated residual block (S2450). In addition, it may be determined whether LFNST applies to the current block (S2460). Determination of S2460 may be performed based on st_idx or lfnst_idx (NSST idx). For example, it may be determined that LFNST does not apply when st_idx is 0 and LFNST applies when st_idx is greater than 0. However, without being limited thereto, an image encoding apparatus may perform step S2460 using various methods. When LFNST does not apply, a transform coefficient generated by primary transform may be encoded into a bitstream without being subjected to secondary transform (S2480). When LFNST applies to the current block, secondary transform may be performed with respect to the transform coefficient generated by primary transform (S2470). The transform coefficient generated by secondary transform may be encoded into the bitstream (S2480). At this time, after an LFNST transform set is determined based on an intra prediction mode and a transform kernel to be used for inverse secondary transform is selected, secondary transform of step S2470 may be performed based on the selected transform kernel. As information on the selected transform kernel, st_idx may be encoded and signaled.

According to another embodiment of the present disclosure, without signaling an LFNST index for a block to which MIP applies, the LFNST index may be derived and used according to a predetermined method. A secondary transform/inverse transform process of this case may be performed according to the method described with reference to FIG. 22, and selection of the transform kernel in step S2250 may be performed based on the LFNST index derived according to the predetermined method. Alternatively, a separate optimized transform kernel for the block to which MIP applies may be predefined and used. According to the present embodiment, while an optimal LFNST kernel is selected for the block to which MIP applies, an effect for reducing the amount of bits for encoding the same may be obtained. Derivation of the LFNST index may be performed based on at least one of a reference line index for intra prediction, an intra prediction mode, a size of a block, or whether to apply MIP. In addition, in order to select an LFNST transform set, as in the embodiment described with reference to FIG. 22, an MIP mode may be transformed into or mapped to a normal intra prediction mode. In the present embodiment, the LFNST index is derived and used without being directly encoded, the syntax of the CU may be the same as in Table 14.

According to another embodiment of the present disclosure, for a block to which MIP technology applies, a binarization method of the LFNST index may be adaptively performed. More specifically, the number of applicable LFNST transform kernels may be used differently depending on whether MIP applies for the current block, and thus the binarization method of the LFNST index may be selectively changed. For example, one LFNST kernel is used for the block to which MIP applies, and this kernel may be one of LFNST kernels applying to a block to which MIP does not apply. Alternatively, for the block to which MIP applies, a separate kernel optimized for the block to which MIP applies is defined and used, and this kernel may not be an LFNST kernel applying to the block to which MIP does not apply. According to the present embodiment, by using a reduced number of LFNST kernels for the block to which MIP applies compared to the block to which MIP does not apply, overhead according to transmission of the LFNST index may be reduced and a complexity reduction effect may be obtained. For example, as shown in Table 15, a binarization process for st_idx and a cMax value may be determined differently according to an intra_mip_flag value.

TABLE 15

| Syntax | | Binarization | |
|---|---|---|---|
| structure | Syntax element | Process | Input parameters |
| | ...... | ....... | ...... |
| | st_idx[ ][ ] | TR | cMax = 2, |
| | intra_mip_flag[ ][ ] = = false | | cRiceParam = 0 |
| | st_idx[ ][ ] | FL | cMax = 1 |
| | intra_mip_flag[ ][ ] = = true | | |

According to another embodiment of the present disclosure, another method of transmitting information on LFNST for the block to which MIP technology applies may be provided. In the above-described example, as information for LFNST, a single syntax such as st_idx is transmitted, it specifies that LFNST does not apply when st_idx has a value of 0 and st_idx indicates a transform kernel to be used for LFNST when st_idx has a value greater than 0. That is, whether to apply LFNST and the type of the transform kernel to be used for LFNST may be specified using a single syntax. According to the embodiment of the present disclosure, information for LFNST may include st_flag which is a syntax indicating whether to apply LFNST and st_idx_flag which is a syntax indicating the type of the transform kernel used for LFNST when applying LFNST.

Table 16 shows a syntax of a CU according to another method of transmitting information for LFNST.

TABLE 16

| | |
|---|---|
| ... | |
| if( Min( cbWidth, cbHeight ) >= 4 && sps_st_enabled_flag = = | |
| 1 && CuPredMode[ x0 ][ y0 ] = = MODE_INTRA | |
| && IntraSubPartitionsSplitType = = ISP_NO_SPLIT ) { | |
| if( ( numSigCoeff > ( ( treeType = = SINGLE_TREE ) | |
| ? 2 : 1 ) ) && numZeroOutSigCoeff = = 0) { | |
| st_flag[ x0 ][ y0 ] | ae(v) |
| if ( st_flag[ x0 ][ y0] ) | |
| st_idx_flag[ x0 ][ y0 ] | ae(v) |
| } | |
| ... | |

As shown in Table 16, information st_flag specifying whether LFNST applies to the current block may be signaled, and information st_idx_flag specifying an LFNST transform kernel may be signaled when LFNST applies to the current block (when st_flag is 1).

In addition, similarly to the embodiment described with reference to Table 15, different numbers of LFNST transform kernels may be used for a block to which MIP applies and a block to which MIP does not apply. For example, only one LFNST transform kernel may be used for the block to which MIP applies. At this time, the transform kernel may be one of LFNST transform kernels applying to the block to which MIP does not apply, and may be a separate transform kernel optimized for the block to which MIP applies. In this case, the transmission method of Table 16 may be changed as shown in Table 17.

TABLE 17

| | |
|---|---|
| . . . | |
| if( Min( cbWidth, cbHeight ) >= 4 && sps_st_enabled_flag == | |
| 1 && CuPredMode[ x0 ][ y0 ] = = MODE_INTRA | |
| && IntraSubPartitionsSplitType == ISP_NO_SPLIT ) { | |
| if( ( numSigCoeff > ( ( treeType == SINGLE_TREE ) ? | |
| 2 : 1 ) ) && numZeroOutSigCoeff == 0) { | |
| st_flag[ x0 ][ y0 ] | ae(v) |
| if ( st_flag[ x0 ][ y0 ] && !intra_mip_flag[ x0 ][ y0 ] ) | |
| st_idx_flag[ x0 ][ y0 ] | ae(v) |
| . . . | |

As shown in Table 17, st_idx_flag may be transmitted only when intra_mip_flag is 0. That is, st_idx_flag may not be transmitted when MIP applies to the current block.

st_flag of Table 16 and Table 17 may be information specifying whether LFNST applies to the current block and may be inferred to be 0 when being not present in a bitstream. In the present disclosure, st_flag may be inferred to as lfnst_flag. In addition, st_idx_flag may specify one of two candidate kernels included in the selected LFNST transform set. When st_idx_flag is not present in the bitstream, the value thereof may be inferred to be 0. In the present disclosure, st_idx_flag may be referred to as lfnst_idx_flag or lfnst_kernel_flag.

In the examples of Table 16 and Table 17, a binarization process of st_flag and st_idx_flag may be shown in Table 18.

TABLE 18

| Syntax | | Binarization | |
|---|---|---|---|
| structure | Syntax element | Process | Input parameters |
| | ... ... | ... ... . | ... ... |
| | st_flag[ ][ ] | FL | cMax = 1 |
| | st_idx_flag[ ][ ] | FL | cMax = 1 |

In addition, ctxInc according to a context coded bin of st_flag and st_idx_flag may be shown in Table 19.

TABLE 19

| | binIdx | | | | | |
|---|---|---|---|---|---|---|
| Syntax element | 0 | 1 | 2 | 3 | 4 | >= 5 |
| . . . | . . . | . . . | . . . | . . . | . . . | . . . |
| st_flag[ ][ ] | 0, 1 | na | na | na | na | na |
| st_idx_flag[ ][ ] | bypass | na | na | na | na | na |

As shown in Table 19, ctxIdx of st_flag may have a value of 0 or 1 when binIdx is 0. For example, ctxInc of st_flag may be derived by Equation 12.

ctxInc=(tu_mts_idx[x0][y0]==0&&treeType!=SINGLE_TREE)?1:0 [Equation 12]

As shown in Equation 12, a value of ctxInc used for coding of st_flag may be determined differently based on a treetype and/or tu_mts_idx value for a current block. A context model used for coding of st_flag (based on CABAC) based on the ctxInc may be derived. Specifically, the context model may be derived by determining a context index ctxIdx, and ctxIdx may be derived as a sum of a variable ctxIdxOffset and ctxInc. In addition, st_idx_flag may be bypass-encoded/decoded. Bypass encoding/decoding may mean encoding/decoding an input bin by applying a uniform probability distribution instead of allocating a context.

According to the examples described with reference to Table 16 and Table 17, by using a reduced number of LFNST kernels for the block to which MIP applies compared to the block to which MIP does not apply, overhead according to transmission of the index may be reduced and a complexity reduction effect may be obtained. In addition, as described above, a value of ctxInc used for coding of st_flag may be determined differently based on a treetype and/or tu_mts_idx value for the current block.

According to another embodiment of the present disclosure, when using the binarization method and/or syntax transmission method described with reference to Table 15 to Table 19, an LFNST transform kernel may be derived and used. When LFNST applies to the current block to which MIP applies, without signaling information for selecting the LFNST transform kernel, one of transform kernels configuring an LFNST transform set may be selected through a derivation process or a separate optimized transform kernel for a block to which MIP applies may be selected. In this case, while an optimal LFNST transform kernel is selected for a block to which MIP applies, an effect of reducing the amount of bits for signaling the same may be obtained. Selection of the LFNST transform kernel may be performed based on at least one of a reference line index for intra prediction, an intra prediction mode, a size of a block or whether to apply MIP. In addition, in order to select the LFNST transform set, as in the embodiment described with reference to FIG. 22, the MIP mode may be transformed into or mapped to a normal intra prediction mode.

Various embodiments according to the present disclosure may be used alone or in combination with other embodiments.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

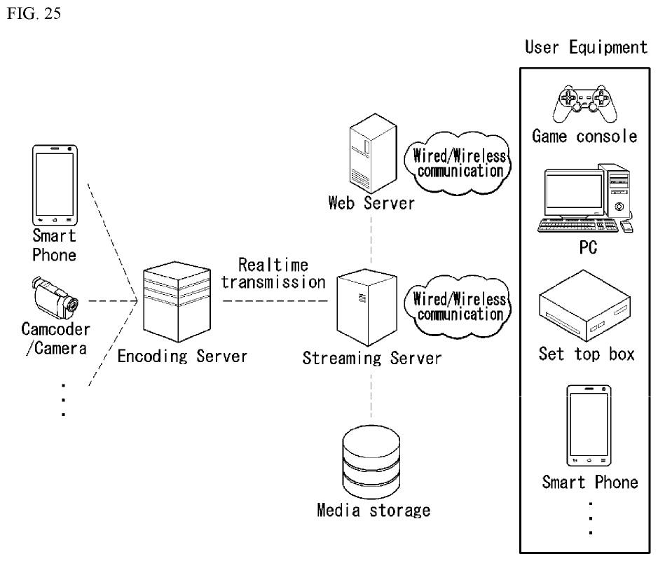

FIG. 25 is a view showing a content streaming system, to which an embodiment of the present disclosure is applicable.

As shown in FIG. 25, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content are received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
generating a prediction block by performing intra prediction with respect to a current block;
generating a residual block by performing inverse transform with respect to a transform coefficient of the current block; and
reconstructing the current block based on the prediction block and the residual block,
wherein the inverse transform comprises inverse primary transform and inverse secondary transform, and the inverse secondary transform is performed based on whether intra prediction for the current block is matrix based intra prediction (MIP).

2. The image decoding method of claim 1, wherein the inverse secondary transform is performed only upon determining that inverse secondary transform is performed with respect to the transform coefficient.

3. The image decoding method of claim 2, wherein the determination as to whether inverse secondary transform is performed with respect to the transform coefficient is performed based on information signaled through a bitstream.

4. The image decoding method of claim 1, wherein the inverse secondary transform comprises:
determining a transform set of inverse secondary transform based on an intra prediction mode of the current block;
selecting one of a plurality of transform kernels included in the transform set of the inverse secondary transform; and
performing the inverse secondary transform based on the selected transform kernel.

5. The image decoding method of claim 4, wherein, based on the intra prediction for the current block being MIP, the intra prediction mode of the current block used to determine the transform set of the inverse secondary transform is derived as a predetermined intra prediction mode.

6. The image decoding method of claim 5, wherein, based on the intra prediction for the current block being MIP, the predetermined intra prediction mode is derived from an MIP mode of the current block based on a predefined mapping table.

7. The image decoding method of claim 5, wherein, based on the intra prediction for the current block being MIP, the predetermined intra prediction mode is derived as a planar mode.

8. The image decoding method of claim 1, wherein, based on the intra prediction for the current block being MIP, inverse secondary transform for the transform coefficient is skipped.

9. The image decoding method of claim 1, wherein, based on the intra prediction for the current block being MIP, information specifying whether inverse secondary transform is performed with respect to the transform coefficient is not signaled through a bitstream.

10. The image decoding method of claim 1, wherein, based on the intra prediction for the current block being MIP, a transform kernel for inverse secondary transform of the transform coefficient is determined to be a predetermined transform kernel, without being signaled through a bitstream.

11. The image decoding method of claim 1, wherein the number of transform kernels available in a case where the current block is subjected to MIP is less than the number of transform kernels available in a case where the current block is not subjected to MIP.

12. The image decoding method of claim 1,
wherein first information specifying whether inverse secondary transform applies to the current block and second information specifying a transform kernel used for the inverse secondary transform are signaled as separate information, and
wherein the second information is signaled based on the first information specifying that inverse secondary transform applies to the current block.

13. An image decoding apparatus comprising:
a memory; and
at least one processor,
wherein the at least one processor is configured to:
generate a prediction block by performing intra prediction with respect to a current block;
generate a residual block by performing inverse transform with respect to a transform coefficient of the current block; and
reconstruct the current block based on the prediction block and the residual block,
wherein the inverse transform comprises inverse primary transform and inverse secondary transform, and the inverse secondary transform is performed based on whether intra prediction for the current block is MIP.

14. An image encoding method performed by an image encoding apparatus, the image encoding method comprising:
generating a prediction block by performing intra prediction with respect to a current block;
generating a residual block of the current block based on the prediction block; and
generating a transform coefficient by performing transform with respect to the residual block,
wherein the transform comprises primary transform and secondary transform, and the secondary transform is performed based on whether intra prediction for the current block is MIP.

15. A method of transmitting a bitstream generated by the image encoding method of claim 14.
